(19) United States
(12) Patent Application Publication
(10) Pub. No.: US 2020/0005063 A1
(43) Pub. Date: Jan. 2, 2020

(54) SYSTEMS AND METHODS FOR ELECTRONICALLY IDENTIFYING PLANT SPECIES

(71) Applicant: PlantSnap, Inc., Telluride, CO (US)

(72) Inventors: Eric Ralls, Telluride, CO (US); Ivan Iliev, Sofia (BG)

(21) Appl. No.: 16/569,110

(22) Filed: Sep. 12, 2019

Related U.S. Application Data
(63) Continuation of application No. 15/973,660, filed on May 8, 2018.
(60) Provisional application No. 62/730,395, filed on Sep. 12, 2018.
(60) Provisional application No. 62/782,685, filed on Dec. 20, 2018.

(51) Int. Cl. G06K 9/00; G06K 9/62; G06K 9/22; G06F 16/51; G06F 16/583

(52) U.S. Cl. CPC G06K 9/00979; G06K 9/6256; G06N 20/00; G06F 16/51; G06F 16/5838; G06K 9/22

(57) ABSTRACT

A system is described that comprises an application configured to use an object detection model to detect and locate an image category across image frames of image data in real time, the detecting and locating including visualizing the location of the image category in a highlighted view across the image frames using an electronic display, the detecting and locating including capturing a frame of the image data as an image for image recognition. The application is configured to provide the image to one or more applications running on a remote server, the one or more applications configured to process the image to identify a species of a plant appearing in the image, the one or more applications configured to provide an identification of the species to the application, the application configured to receive an instruction to post the image and the species identification.

### RELATED APPLICATIONS

This application is a continuation application of U.S. application Ser. No. 15/973,660, filed May 8, 2018, which claims the benefit of U.S. App. No. 62/503,068, filed May 8, 2017. This application claims the benefit of U.S. App. No. 62/730,395, filed Sep. 12, 2018, and U.S. App. No. 62/782,685, filed Dec. 20, 2018.

### TECHNICAL FIELD

The disclosure herein involves an electronic platform for identifying plant species.

### BACKGROUND

There is an overwhelming number of plant species on the earth from the most exotic locations to backyard environments. Often, hikers, climbers, backpackers, and gardeners may encounter unknown plant species. There is a need to facilitate identification using a convenient electronic platform when circumstances prevent identification through conventional methods.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 show a point of entry for images into the Plantsnap environment and image processing workflow, under an embodiment.

FIG. 2 shows a method for data collection and processing, under an embodiment.

FIG. 3 shows image capture and processing workflow, under an embodiment.

FIG. 4 shows a screen shot of an application interface, under an embodiment.

FIG. 5 shows a screen shot of an application interface, under an embodiment.

FIG. 6 shows a screen shot of an application interface, under an embodiment.

FIG. 7 shows a screen shot of an application interface, under an embodiment.

FIG. 8 shows a screen shot of an application interface, under an embodiment.

FIG. 9 shows a screen shot of an application interface, under an embodiment.

FIG. 10 shows a screen shot demonstrating object detection, under an embodiment.

FIG. 11 shows a screen shot of an application interface, under an embodiment.

FIG. 12A shows a screen shot of an application interface, under an embodiment.

FIG. 12B shows a screen shot of an application interface, under an embodiment.

FIG. 13 shows a screen shot of an application interface, under an embodiment.

FIG. 14 shows a screen shot of an application interface, under an embodiment.

FIG. 15 shows a screen shot of an application interface, under an embodiment.

FIG. 16 shows a screen shot of an application interface, under an embodiment.

FIG. 17 shows a screen shot of an application interface, under an embodiment.

FIG. 18 shows an application workflow diagram, under an embodiment.

FIG. 19A shows a screen shot of an application interface, under an embodiment.

FIG. 19B shows a screen shot of an application interface, under an embodiment.

FIG. 20 shows a screen shot of an application interface, under an embodiment.

FIG. 21 shows a screen shot of an application interface, under an embodiment.

FIG. 22 shows a screen shot of an application interface, under an embodiment.

FIG. 23A shows a screen shot of an application interface, under an embodiment.

FIG. 23B shows a screen shot of an application interface, under an embodiment.

FIG. 23C shows a screen shot of an application interface, under an embodiment.

FIG. 24 shows a screen shot of an application interface, under an embodiment.

FIG. 25 shows a screen shot of an application interface, under an embodiment.

FIG. 26 shows a system for object detection, plant identification, and sharing of plant identification, under an embodiment.

### DETAILED DESCRIPTION

A platform is described herein that electronically identifies plant species using images captured by a mobile computing device. This disclosure explains the functions performed by an application, i.e. the Plantsnap application, along with the necessary backend functions needed to support these functions. The application enables users to perform a variety of functions that facilitate identification of plant species, learning about plants, and communicating with others, and sharing information with a community. The Plantsnap application and backend services may be referred to as the Plantsnap application, the application, the Plantsnap platform, and/or the platform.

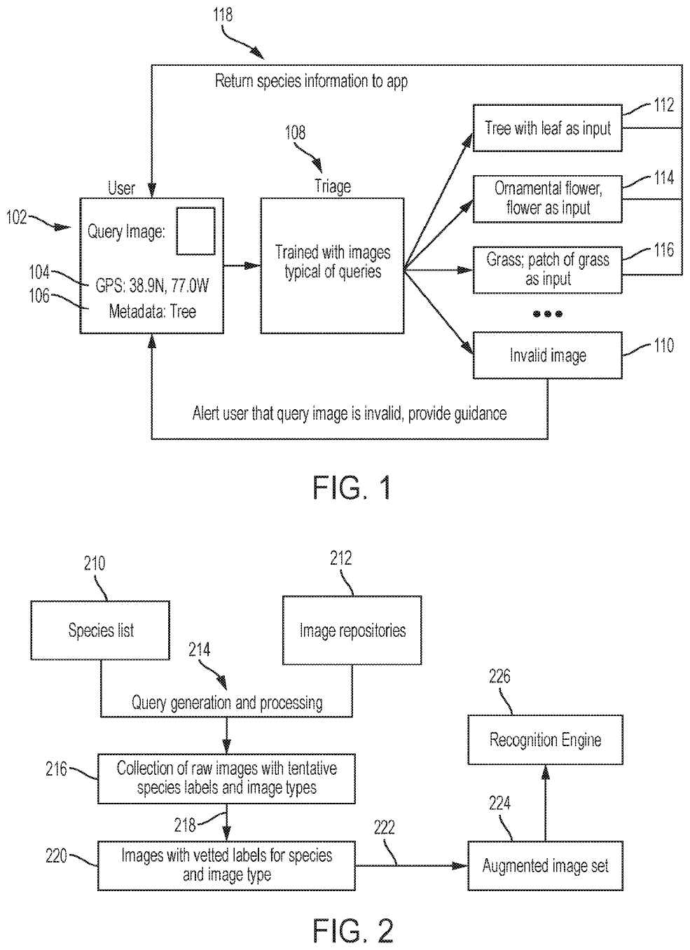

FIG. 1 shows a workflow of the Plantsnap application under one embodiment. The user of the application queries the Plantsnap system with an image, GPS and metadata. Rather, the user may snap a photo of a plant using a smartphone or other mobile device running the Plantsnap application. The smartphone reports the GPS coordinates of the image and metadata. Metadata is collected by the smartphone GPS and may also be reported by users through commentary or other input. The query is passed to a triage recognition engine, which directs the query to a specialized recognition engine suitable for this query. (Note that an image recognition engine does not require GPS or other metadata for operation under one embodiment. In other words, the image recognition engine may operate upon a plant image alone). Systems and methods for implementing this specialized recognition are disclosed herein.

### 1. Visual Recognition

The application assists the user in making queries that help identify a plant's species.

a. Image-based queries: The user may be able to take a photograph of some part of a plant to use as a search key. The application's interface guides the user to take appropriate photographs. Photographs may contain a single leaf, a close-up image of a flower, or a close-up image of a whole plant, if the plant is small.

b. GPS: In addition, users enable GPS services under an embodiment; user location may be used to filter responses.

c. Additional Metadata: The user may also enter some basic information about the plant through a menu interface. For example, is this a tree, a bush, or a flower?

d. Responses: The application responds with an ordered list of the top matching plant species. The Plantsnap application may include some level of confidence associated with each response. Each response is under an embodiment linked to additional data about the species.

### 2. Plant Information

For each species in the application, the user is provided with image and text information. The images should illustrate the appearance of different features of the plant, such as its leaves, bark, flowers and fruit. The text may include descriptions of the appearance of the plant, its geographic locations, and its uses. The application may also include hyperlinks to external sites. These may include sites such as Wikipedia. The application could also include links to local stores where these plants, or plant care products, are available for purchase.

### 3. Browsing

The application provides under an embodiment a mechanism for searching species by name or browsing through a particular subset of the species in the application (e.g., trees, ornamental flowers, vegetables).

### 4. Collection

The user is able to create under an embodiment a personal collection of images. This allows reference to images taken before, along with any notations and GPS locations indicating where the images were taken.

### 5. Communication

a. Labeling: The application provides under an embodiment a mechanism that allows users to label the species of a plant. These labels may be associated with a user's personal collection, and uploaded to the Plantsnap dataset, allowing the platform to acquire additional training data.

b. Posting and answering questions: Users should be able to post their questions to other users, and chat with users to assist in identification.

c. Posting Collections: Users should be able to post their collections with GPS locations, allowing others to make use of their identifications.

### 6. Scope of Dataset

The Plantsnap application covers under one embodiment between one thousand and several thousand species of plants in the Continental US, excluding tropical regions such as southern Florida. One embodiment covers species across the world. As one example, an embodiment may cover 250,000 across the world. One embodiment includes 350,000 across the world. These species may be selected based on their importance (how common they are and how much do people care about them). These species of plants are grouped into a few classes, allowing construction of a separate recognition engine for each class. These classes might include trees, ornamental flowers, weeds, and common backyard plants. The scope of the dataset is under one embodiment determined with input from professional botanists.

Under another embodiment, the application extends coverage to handle all species of interest in this geographic region. The application may exclude species that are very rare and that are not of interest to most users (e.g., moss), or that are difficult to identify properly from images. The application interface and workflows may clearly explain to the user what is not covered, so that a user understands the scope of the Plantsnap application capabilities, under an embodiment.

### 7. Gaming

The application may contain games aimed at educating users about nature and the world around them. These games may run purely on a phone, such as games in which the user is shown several leaves or flowers and asked to identify them. Or the application may include gamification as part of the Plantsnap application. This involves under one embodiment collecting games, in which users compete to collect images of the 20 most common trees in their neighborhood. An alternative embodiment includes a system of points, earned for prestige, that reflect how many species a user has collected, or that credits users for helping to identify plants that other users have collected. Such games make the application more appealing for classroom use and foster a network of users.

### 8. Performance:

a. Speed: Images taken in the application are uploaded to a central server. This upload represents the primary bottleneck on system performance under an embodiment; computation time on the server should be negligible.

b. Accessibility: The application is not under one embodiment able to perform recognition without network connectivity under one embodiment. Other functions, such as browsing species or referring to one's collection should be unimpaired by a lack of connectivity (but may also require internet connectivity under an embodiment).

c. Accuracy: A chief measure of accuracy is how often the application places the correct species either at the top or in the top five of its responses. Success may increase for carefully taken queries; performance in the field by ordinary users may be lower.

### 9. Platforms

The application runs on multiple mobile computing operating systems including iOS or Android. Users may also interact with the Plantsnap application through a web interface.

One embodiment of the application may create a version of the application for classroom use that contains only common plants found in a local region. Versions of the application may be created for each National Park. The application may also provide the ability for users to create their own versions of the Plantsnap platform. This may allow a middle school class, for example, to create a version of the application containing plants that the students identified themselves, illustrated with images that the students have taken.

Image recognition may operate as follows under an embodiment:

### 1. Triage

Under one embodiment, an image is fed into a recognition engine that determines the type of image that the user has uploaded. Possible image types may include: “leaf”, “flower”, “whole plant”, or “invalid”. The image determines which recognition engine may be used to determine species. If an image is judged to be invalid, the user is alerted. The application may then guide/instruct the user to take better images.

### 2. Species ID

Each species identification classifier is tuned under an embodiment to a particular class of plants and a particular type of input. In an initial release, image recognition engines and corresponding inputs comprise:

a. Trees, using images of isolated leaves as input.

b. Ornamental flowers, using an image of the flower as input.

c. Bush and shrubs, using an image of a leaf as input.

d. Common backyard plants (e.g., basil, tomato plants, ferns, hosta, poison ivy, weeds) using a close-up picture of the whole plant.

e. Grass, using a picture of a patch of grass.

Alternative embodiments may allow users to enter queries using multiple pictures. For example, a user may submit a picture of a leaf and a second picture of bark, when attempting to identify a tree.

The application may under an embodiment provide different recognition engines for different geographic regions. For example, by creating different engines for the trees of the Eastern US and for the trees of the Western US Plantsnap is able to improve species identification.

The key to achieving high recognition rates is in constructing appropriate data sets to use in training. A third-party image recognition platform creates recognition engines based on the data sets provided to such platform.

### Data Collection and Processing

A variety of different image datasets are created to support Plantsnap. These image datasets include:

### 1. Query Datasets.

These contain images that resemble the images that users may submit when querying the system. So, for example, if we want a recognition engine to be able to identify a red maple from an image of its leaf, we will need images of isolated leaves from red maple trees that capture the variation we expect to see both in the leaves themselves, and in the imaging conditions. On the order of 300 images per species and query type are required under one embodiment (e.g. 300 images of leaves from red maple trees for this example).

### 2. Augmented Query Datasets.

It is difficult to capture the entire variability of the picture-taking process through images found on the web. One embodiment of the Plantsnap backend database creation significantly improves the robustness and accuracy of the recognition engines by processing real images to generate new images that may resemble images that users might take, but that are not available through any above referenced image capture process. As a simple example, given an image of a plant, an embodiment of the database creation process may rotate the image a bit, or create different cropped versions of the image, to mimic the images that would have been taken had a user's camera position or angle been slightly different. Given images of leaves on plain backgrounds, a method of new image creation may segment the leaf and superimpose it on images of a variety of common backgrounds, such as sidewalks or dirt. This may improve the ability to recognize such images when they are submitted.

### 3. User Images.

As users upload and tag images the Plantsnap application is able to make use of these images to improve the platform. Most importantly, user uploads provide many real-world examples of images, identified by species. These images may be used to retrain the recognition engines and improve performance. These images may also provide the platform with more up-to-date information on the geographical distribution of plant species. User images may also provide us with examples of invalid images, which are described next.

### 4. Examples of Invalid Images.

To identify images that users may submit that are not suitable for identification, examples of such inappropriate images are used under an embodiment. Initially, these are sampled from random images that do not depict plants. Once the application is deployed, unsuitable image detection may be improved by finding inappropriate images submitted by users.

### 5. Illustrative Images.

Under an embodiment images that may not be suitable for recognition, may nevertheless inform the user as to the appearance of each plant. A recognition engine may under an embodiment identify tree species using images of isolated leaves. The application may augment the results by showing users images of whole trees, or other parts of the tree (bark, flowers, fruit).

The creation and maintenance of datasets may require several steps and may be facilitated by a number of automated tools.

### 1. Identification of Species and Image Types.

In consultation with botanists, a list of species is identified for inclusion in the initial release. For each species, an embodiment of the application identifies the type of image that will be used to identify the plant.

### 2. Harvesting Raw Images.

Some of the appropriate images may come from curated datasets (e.g., USDA, Encyclopedia of Life). Others may be found through image searches (eg., Google™ or flickr™).

### 3. Filtering and Metadata.

Images found in step 2 may already be associated with some species information. However, this species information may or may not be reliable, depending on the source. Many images may be wholly unsuitable. For example, Googling “rose” may turn up drawings of a rose. In addition to the species, though, we must identify the type of each image. Does it show an isolated leaf, a flower or a whole plant.

Some of this filtering can be done with the assistance of automation. For example, a triage engine, designed to find invalid images, may also determine that some images downloaded from flickr™ are invalid. Images may be automatically or manually identified as invalid. Tools may be developed to determine the type of each image. These tools are not perfect but may provide useful initial classifications. Additional metadata may be provided by workers on Amazon's Mechanical Turk, as needed, e.g. common name, species name, habitat, scientific nomenclature, etc.

FIG. 1 shows a point of entry for images into the Plantsnap environment. A user uses the camera of a smartphone under an embodiment to capture or “query” an image 102. The GPS functionality of the smartphone associates GPS location coordinates 104 of the user with image. Under the example of FIG. 1, the user queries an image at location GPS: 38.9N, 77.0W. The user may also provide metadata information 106. For example, the user specifies that the image is a tree. The Plantsnap application then passes the image to a remote server running one or more applications, i.e. a Triage recognition unit, for identifying the image 108. As further described herein, the triage recognition unit is trained with images typical of queries and with invalid images. If the Triage recognition unit identifies an invalid image, the recognition unit transmits the information to the application which notifies the user via the application interface. The recognition unit may identify a tree using a leaf image as input 112. The recognition unit may identify an ornamental flower using a flower image as input 114. The recognition unit may identify grass using a patch of grass as input 116. The triage recognition unit then returns the identification information 118, i.e. the identified species, to the application which then which notifies the user via the application interface. If the image is invalid 110, the recognition unit may return this information to the application.

FIG. 2 shows a method for data collection and processing. The method includes compiling a species list 210 produced with assistance from botanists. Images of species included in the list may be obtained through image repositories 212, i.e. images may be harvested from curated datasets (e.g., USDA, Encyclopedia of Life). Others may be found through image searches (eg., Google™, flickr™, and Shutterstock™). Query generation and processing 214 produces a collection of raw images with tentative species labels and image types 216. The method then implements 218 quality control of species ids and image types using recognition engines and Mturk workers. The method produces 220 images that are labeled for species and image type. The method uses 222 computer vision and image processing algorithms to generate a larger image set with greater variation. Computer vision tasks include methods for acquiring, processing, analyzing and understanding digital images, and extraction of high-dimensional data from the real world in order to produce numerical or symbolic information, e.g., in the forms of decisions. The method therefore produces an augmented data set 224. The method then uses an image recognition platform to build the recognition engine 226.

The image recognition platform comprises computer models trained on a list of possible outputs (tags) to apply to any input. Using machine learning, a process which enables a computer to learn from data and draw its own conclusions, the image recognition models are able to automatically identify the correct tags for any given image or video. These models are then made easily accessible through a simple API.

The Plantsnap platform includes a database of plants subject to identification. The database includes the following columns: DataBase Name, Scientific Name of Plant, Genus Name and Species Name, Scientific Names Lookup With Already Processed Name, Common Name of Plant, Common Name Lookup With Processed Names, and Comment.

The present disclosure relates to an application for identifying plants preferably utilized with Smart Phones which allows a user to take at least one image of a plant such as a tree, grass, flower or a plant portion. The application and backend services compare the image(s) to a database of at least one of images, models and/or date and then provide identifying information to the user related to the plant.

Shazam™ is a downloadable application which can be downloaded on the iPhone or other Smart Phone which allows a user to utilize a microphone to “listen” to a song as it is being played. A processor then identifies a song correlating to the played song, if possible, based on comparison to a database of entries. This allows users to identify songs and/or then provide information about specific songs.

As another example, Google™ provides an application allowing users to take a picture of a famous landmark. The application then compares that picture to information in a database to identify that landmark and provide information about it.

There is a need for improved methods of identifying plant genus and species. Identification of plant species presents unique difficulties. In contrast to landmarks, plant form and shape are variable over time for individual plants and across plants belonging to the same species. Accordingly, a need exists for an improved application for identifying plants.

An embodiment described herein uses a smartphone camera to capture a plant image and to provide the image to an application and backend services for identification. The application and backend services identify the plant based on a comparison of the image with database images, models and data associated with known plants. The application compares the image(s) to database entries in an effort to accurately estimate the type of plant being investigated by the user and then provide information relative thereto.

Under an embodiment a mobile device application is provided. The mobile device comprises a camera. Mobile devices include the iPhone™ and various Android™ based phones available on the market as well as Blackberry™ and other devices. These devices comprise a camera to capture either still or moving images.

A user may take a still image, if not a video image, of a particular plant or portion thereof. A processor of an application or backend remote server application compares the image(s) to database entries and then determines which of the models, images and/or preloaded information the images most closely resemble. An output is then provided which identifies at least one if not a plurality of options which most closely resemble the image, while providing information about the plant(s) such as the name of the plant, flower, grass, tree, shrub or other plant or portion thereof.

The application may be configured to orient the image relative to stored images in the database and/or orient database entries to attempt to match the captured image(s) so that the captured image or images could be compared to those maintained by the system. Each of the image or images may be analyzed relative to stored images, models and/or date under similar or dissimilar perspectives depending upon the embodiment employed. When analyzing the taken images relative to database entries, the processor of the application or backend remote server applications typically search/analyze database entries for patterns and/or numerical data related to the pixel data of the captured image and/or other features.

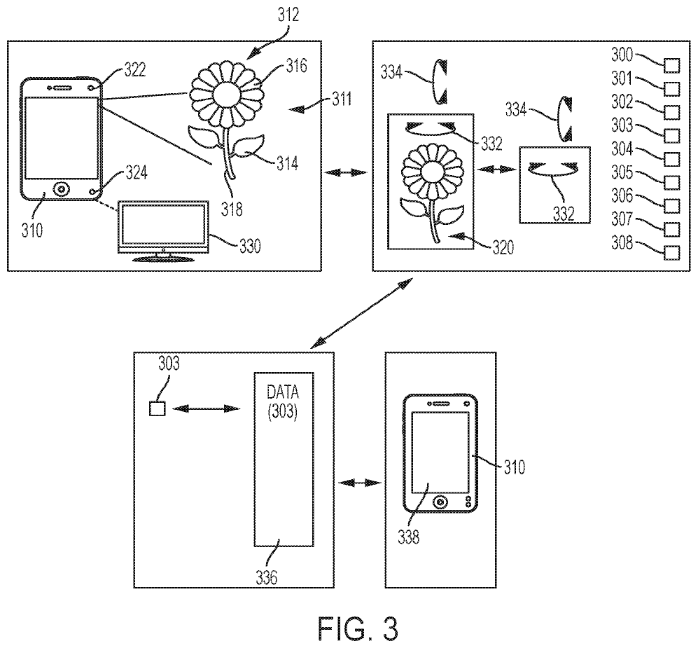

Utilizing different landmarks such as the relative lengths and width of leaves, differing relationships to stalks and/or other components, particularly when combined with color, an embodiment may provide a plant recognition software for various uses. Such uses may include allowing a clerk at a nursery to identify a particular plant at a checkout for appropriate pricing. FIG. 3 shows a smartphone 310 capturing the image of plant or a portion of a plant such as, in this case, a plant portion 312 having two leaves 314, a flower 316 and a stalk 318. The smartphone 310 has a camera 322 which is capable of capturing at least one of still or moving images. After obtaining one of an image 320 or series of images such as in the form of a video with the Smart Phone 310 and/or a camera such as camera 322 connected to a processor such as internal processor 324 (which could alternatively be an external processor such as a computer 330), the image or series of images can then be compared to a series of database entries such as images, models and/or information by at least one of the processors 324, 330. Camera 322 need not be integrated into Smart Phone 310 for all embodiments.

It is possible that each of the database images 300-308 are images, models, or data of existing plants or plant portions possibly having a three-dimensional effect so that either one of the image 320 or series of images can be rotated either in the left or right direction 332 as shown in the figure and/or rotated in the front to back direction 334 so that the image 320 could be manipulated relative to the database entry, such as test image 303.

It is more likely that instead of rotating image 320, that the image 303 is actually a three dimensionally rendering model which could possibly be based on images originally obtained and stored and can now be rotated in directions 332 and 334 so as to attempt to match the orientation of image 320. A match of orientation might be made as closely as possible. Calculations could be made to ascertain the likelihood of the image 320 being represented by the data behind model 303. The process could repeated for models 300-308 (or what is expected to be a large number of images, models and/or data) for a particular image(s) 320.

It may be that data could be entered into the smartphone 310 such as “flower” so that only flower images are used in the identification process. It may also be possible to enter “leaf” so that that only leaves are compared. Alternatively, it may be that subsets of images may be identified for comparison using information derived from image 320. It may also be possible for multiple entries 300-308 to be the same plant, but possibly having at least slightly different characteristics, such as older, younger, newly budding, different variations, different seasons, etc.

Furthermore, it may be that the processor 324, 330 can make a determination as to likely representation of the image 320 as to being a flower, leaf, stem, etc., and then preferentially compare image 320 to a subset of database images. If the likelihood of the match exceeds a predetermined value, then a match may be identified. Furthermore, possible alternative matches may also be displayed and/or identified as well based on the relative confidence of the processor 324 and/or 330.

Once a particular model, such as model 303 is selected as being the most likely match for image 320, then data associated with image 303 (as shown in data 336) may be displayed on display 338 of Smart Phone 310 or otherwise communicated to the user. It is most likely that the data would at least identify the plant corresponding to the plant portion such as shown in FIG. 3. For some embodiments such as for nurseries, namely, the price of the plant corresponding to the plant could be displayed. Other commercial or non-commercial applications may provide this or different data to a user.

When providing the comparison step shown in FIG. 3, it is likely that certain distances or relative distances may be important such as the distance from the tip of the leaf to the base of the leaf possibly relative to the width of the leaf. It may also be that absolute distances can be calculated and/or estimated in some way such as by requiring the user take image 320 from a specific distance to the plant, such at 2 feet, etc. The application may estimate the length of the leaf which may assist in determining which plant or shrub corresponds to a particular portion, particularly if orientations are also specified. Various kind of instructions may be provided to the smartphone 310 such as what orientation the image 320 could be taken to most beneficially minimize the turning of either the image 320 or the model 303 by axes 332 and 334 for the best match, if done at all.

Various height, width and depth information can be useful particularly in relationship to other features of the plant which may be distinguishable from other plants to facilitate match with the database entries 300-308. Furthermore, it may be color is particularly helpful in identifying a particular plant distinguishable from one another which can also be calculated by the processor 324 and/or 330.

The application described herein includes various smartphones 310 such as the iPhone™, various Android™ based phones as well as Blackberry™ or other smartphone technology as available. Basically, any camera 322 connected or coupled to a processor 324 may work as utilized with a methodology shown and described herein. In addition to still images taken with the camera 322, moving images may be taken if the camera has that capability and then such images may be compared to database entries utilizing the methodology shown and described herein.

A user could also input information into the smartphone 310 to assist the process such as the likely age of the photographed image. Absolute measurements, the portion of the plant image such as leaf, flower, and/or other information, etc., may be provided as input to assist the processor(s) 324, 330. Other information may be helpful as well, such as a specific temperate region or zone where the plant is located or whether the plant is in its natural state. Such information may further assist the processor 324, 330 in making the selection. Other information may also be requested, provided and/or analyzed by the processor(s) 324, 330 in an effort to discern the type of plant being identified.

The processor(s) 324, 330 analyzes the image(s) 320 relative to the database entries 300-308 according to at least one algorithm to ascertain which of the entries 300-308 are most likely to correspond to image or images 320. As seen in FIG. 3, entry 303 is identified as the best matching candidate. The data associated with entry 303 namely data 336 has been identified and is then displayed on display 338.

Display 338 may be a portion of smartphone 310. Data 336 may otherwise be communicated through alternative computing displays. Each of the database entries 300-308 are preferably linked to data and/or information in order to include information about the type of plant being identified.

A broader classification of the target plant may be provided, i.e. broader than the actual plant corresponding to image 320. A broader classification of plant, flower, etc., may be particularly helpful. Additional ancillary data may be provided. As one example, it would useful to know that not only is the plant a blueberry bush, but a blueberry bush which tends to produce fruit in the “middle” of the season rather than late or early.

Information displayed as data 336 provided on the display 338 may also include preferred temperature, recommended planting instructions, zones, etc. Such information may be associated with GPS location to predict for example the date a certain fruit ripens and/or other information helpful to users. If the user is a nursery, pricing could be provided. In other embodiments, other information may be provided to the users as would be beneficial in other applications.

A plant identifying application which can identify between various trees, flowers, shrubs, etc., is shown and described herein.

The Plantsnap application may under an embodiment perform the following steps:

Step 1: The user of the application chooses an image either from their camera or the local memory of the device (gallery).

Step 2: The user may reframe the selected image, so that it corresponds to the guidelines of taking a “good” image.

Step 3: The image is saved locally on the device and then uploaded to an Amazon S3 bucket. The URL of the image is used to make a request to Imagga's categorization endpoint for Plantsnap's categorizer. This returns a list of categories, a corresponding proprietary Label ID and corresponding confidence regarding accuracy of identification.

Step 4: The results are visualized in the user application, where separate requests are made for each result to api.plantsnap.com to retrieve the images for each plant for visualization in the user interface.

Step 5: If the user wishes greater details for a given plant, a new request is made to api.plantsnap.com for that particular plant in order to retrieve all the details available.

Step 6: The user may:

A) make a selection to accept one of the proposed results;

B) suggest a name of the plant, if it's not in the proposed results and the user knows the name;

C) send the image for manual identification by a botanist, which saves the snap with a special status.

These images are later reviewed and saved with reviewed names, which are visualized in the user application.

Step 7: The user snap is logged in Plantsnap's proprietary database.

Note that the Plantsnap application may use a third-party API such as Imagga™ API endpoints to tag and classify an image. By sending image URLs to a /tagging endpoint the application may receive a list of automatically suggested textual tags. A confidence percentage may be assigned to each of them so that the application may filter the most relevant or highest priority tag, image type.

A categorizer may then be used to recognize various objects (species). The Plantsnap platform may train categorizers or recognition engines to identify species. An auto categorization API makes it possible to conveniently train such engines. When a request to the ‘/categorizers’ endpoint is made, the API responds with a JSON array of objects each of which describing accessible categorizers. As soon as the best categorizer/classifier is identified, the image may be processed for classification. This is achieved with a simple GET request to this endpoint. If the classification is successful, as a result, the application receives a list of classifications/categories, each with a confidence percentage specifying how confident the system is about the particular result.

Plant image classification is based on machine learning, under an embodiment. This is a process where a computational model is built that represents a classifier of digital images represented as a set of pixels. The model assesses probabilities that an image belongs to a certain class. The model underlying the third-party image recognition API may comprise a convolution neural network trained with back-propagation of probability errors.

Under an embodiment of the Plantsnap platform, the “categorizer” referenced above is updated every month using user images and curated images. Accordingly, the Plantsnap algorithm improves every month.

The application is translated into 37 languages, under an embodiment.

Under one embodiment, image analysis is conducted by one set of servers (Imagga™), and the details and results are provided by Plantsnap servers.

The Plantsnap application/platform may run on laptops, computers, and/or iPad™ devices. The Plantsnap application/platform may run as a web-based application.

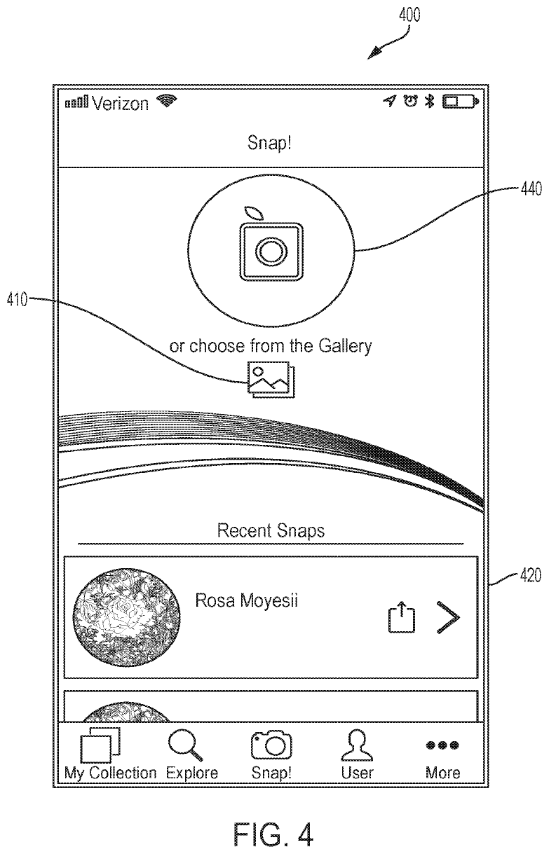

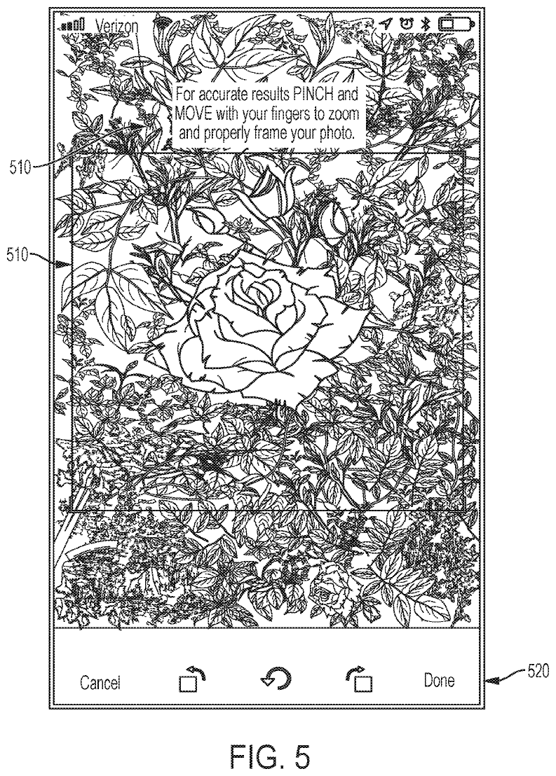

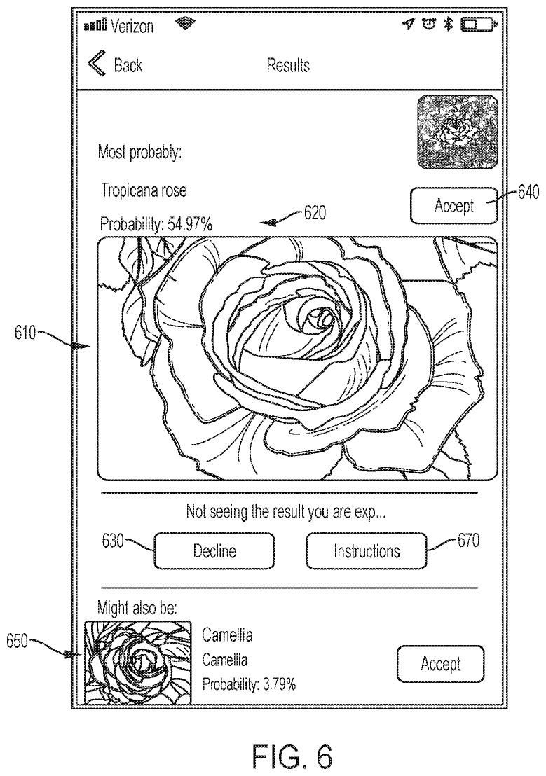

FIG. 4 shows the general snap screen 400 presented to a user when a user starts the application. The user may select a snap option 440 on the snap screen to capture an image of a flower or plant. FIG. 4 also shows recent snap shots 420 analyzed by the application and accepted by the user. Alternatively, a user may select gallery option 410 as further described below. Once a plant/flower is photographed, the application encourages the user to crop the image properly in order to highlight the plant/flower or highlight a selection of leaves. FIG. 5 shows the crop tool 510 of the application, under an embodiment. The Plantsnap application then attempts to identify the plant or flower. Under an embodiment, the application returns an image which comprises the highest likelihood of proper identification. FIG. 6 shows that the application identifies the plant 610 with a 54.97% probability 620 of proper identification. The user has the option of accepting 640 or declining 630 the identification. The user may also select an instruction option 670 to view tutorials instructing proper use of the application's image capture tool. The application provides alternative identifications with corresponding probabilities. Under an embodiment, a user may swipe right to scroll through alternative identifications with a similar option of accepting or declining the identification. Additional potential identifications are presented in a selection wheel 650 of the screen. The user may use this selection wheel to find and accept an alternative plant identification.

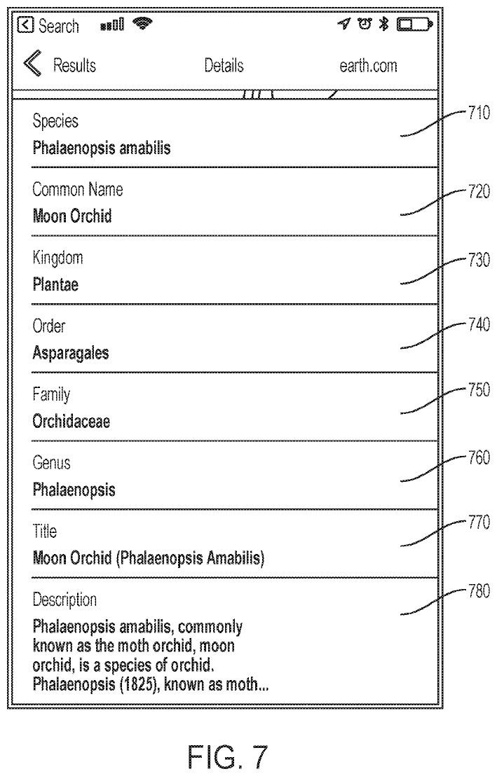

A user may at any time select a plant/flower image. Selection of an image clicks through to a detailed description of the plant/image as seen in FIG. 7. The screen of FIG. 7 shows Species 710, Common Name 720, Kingdom 730, Order 740, Family 750, Genus 760, Title 770, and Description 780 of the plant/flower.

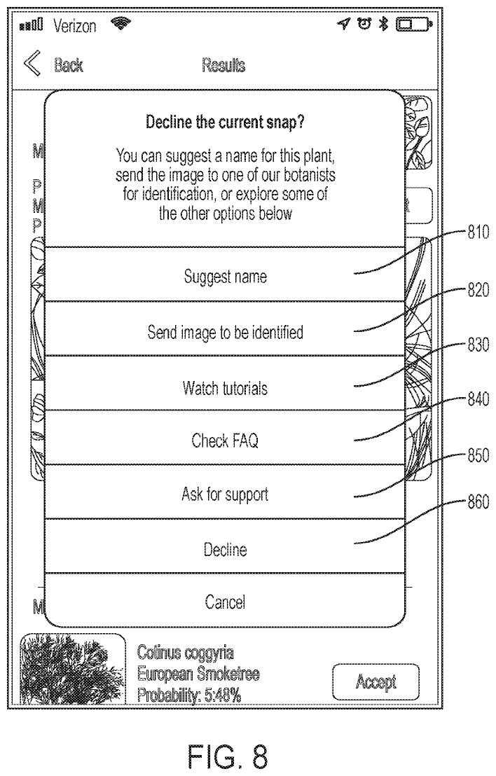

Selection of the decline option (as seen in FIG. 6) passes the user to the screen of FIG. 8. The user may then suggest a name 810, send the image to be identified 820, watch tutorials 830 for instruction in optimizing accuracy of the application's identification process. The user may select Check FAQ 840 to review frequently asked questions. The user may ask for support 850 and send an email to Plantsnap representatives requesting further assistance or instruction. The user may simply decline 860 the current application identification.

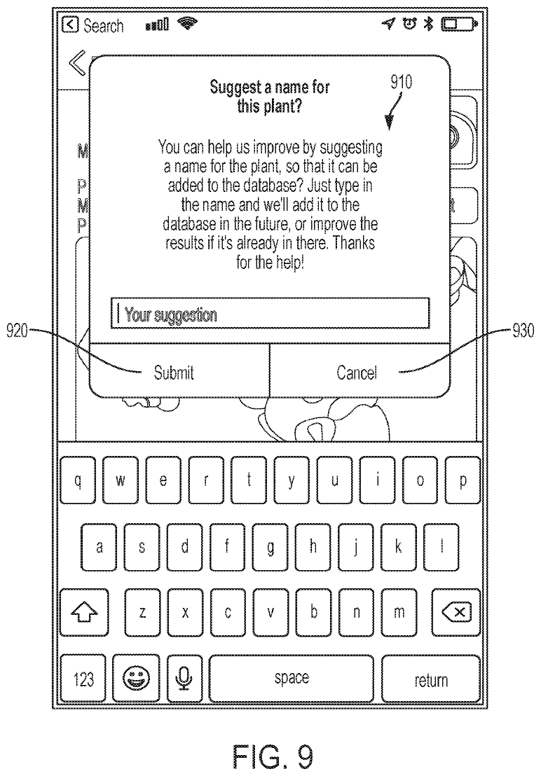

If the user selects the suggest a name option 810, the user is presented with the screen of FIG. 9. The screen prompts the user to suggest a name 910 for the plant/flower. The application requests entry of the name so that it may be added to the Plantsnap database. The screen states: “You can help us improve by suggesting a name for the plant, so that it can be added to the database. Just type in the name and we'll add it to the database in the future or improve the results if its already in there. Thanks for the help!”. The user may submit a name 920 or cancel the screen 930.

The user may either snap an image for identification or retrieve a photograph from a photo gallery for identification (see FIG. 4). Once an image is selected from gallery, the application directs a user through the same workflow described above, under an embodiment.

Under an embodiment, the Plantsnap application logs both snapshots that are saved by the user as well as snapshots that are declined (along with corresponding probability of successful identification). Under an embodiment, the Plantsnap application saves proposed results along with the image captured by the user to enable proper analysis of proper versus improper categorizations.

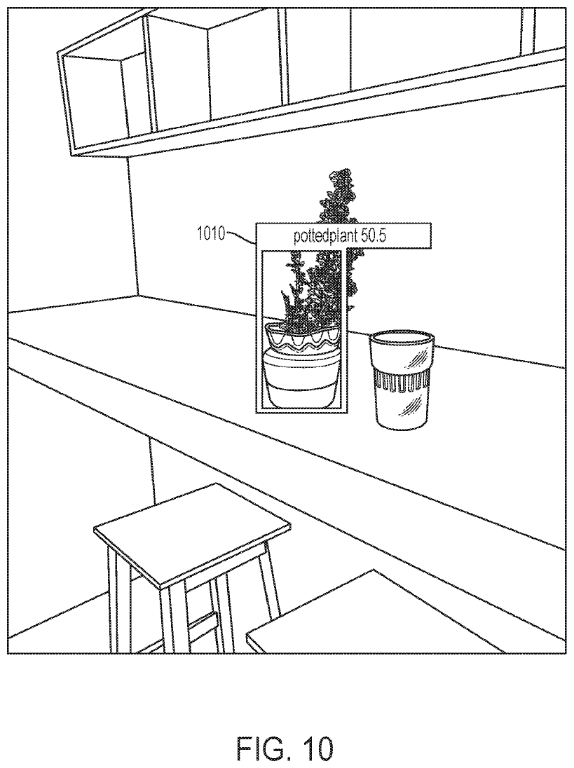

An embodiment of the application may integrate an object detection model. As one example, an applicant running iOS™ may use Apple's™ new machine learning API CoreML released along with iOS11 in the Fall of 2017 and Google's MLKit. Using on-device capabilities, the application is able under an embodiment to detect parts of an image containing a plant and use only those part(s) of the image for performing a categorization. FIG. 10 shows operation of the object detection model including an identified section of the image 1010 comprising a plant. If the model cannot find any potential plants for recognition or if the model incorrectly identifies a portion of an image that is not a plant, then the application may allow the user to select the part of the image subject to recognition.

The systems and methods described herein may use object detection, under an embodiment.

### Object Detection—General Description

Object detection is a form of computer vision, which deals with locating occurrences of known image categories within a digital image and providing a likelihood that the category is correct. The difference between an image categorization model and object detection is that the object detection provides the location of a potential member of a category within a bounding box with known coordinates. This form of object detection may run on handheld devices such as mobile phones and may be performed in real time inside a live camera view, under an embodiment.

### Dataset, Labelling (Annotations), Object Detection Model Training

An object detection model requires a dataset comprising image categories, which are to be detected, as well as annotations in the form of bounding boxes, which define the location of an image category representation in the boundaries of a given image. An image usually contains more than one of the categories, which are included inside the object detection model and may also include overlapping regions of the different categories. Such datasets need to be annotated, under an embodiment, meaning that the categories of images are manually placed within bounding boxes. An annotated set of images includes the images, as well as the coordinates of the bounding boxes of the different categories in a predefined coordinate system. As just one example, an annotated set of images may include the following data, under an embodiment,

[{‘coordinates’: {‘height’: 104, ‘width’: 110, ‘x’: 115, ‘y’: 216}, ‘label’: ‘ball’},

{‘coordinates’: {‘height’: 106, ‘width’: 110, ‘x’: 188, ‘y’: 254}, ‘label’: ‘ball’},

{‘coordinates’: {‘height’: 164, ‘width’: 131, ‘x’: 374, ‘y’: 169}, ‘label’: ‘cup’}]

where height and width comprise measurements of the bounding box and where x and y are measured from the center of the bounding box relative to (0,0), i.e. the upper left corner of the image.

This annotated dataset is used to perform trainings of image detection models, which occur either on a personal computer or inside one of known cloud-enabled services of Google, Amazon or Microsoft. Such could also be run on proprietary hardware with increased GPU computational power, such as NVIDIA's AI-focused machines—NVIDIA DGX.

iOS—Apple, recently released a toolset, called CoreML2, enabling the training of such and other models in an expedited fashion, where these could be performed on a personal computer in a short amount of time. The model, which is the result of such trainings is later used to run complex computer vision (and other) tasks directly on a handheld device. This is an extension of the previously released CoreML Kit.

Android—Google also released a toolkit for such tasks, called MLKit, which can be used to perform such trainings, as well as run computer vision models on a handheld device with high accuracy.

Under an embodiment, an object detection machine learning model (as described above) is used to detect where in the frame a specific object is located. As described above, an ML (machine learning) model may be trained to detect the following plant categories:

1. Leaves, and the following subcategories:
a. Ordinary shaped leaves;
b. Large leaves;
c. Tall slim leaves;
d. Oddly shaped leaves;
e. Multiple leaves;

2. Flowers, and the following subcategories:
a. Ordinary shaped flowers;
b. Ball shaped flowers;
c. Tall slim flowers;
d. Oddly shaped flowers;

3. Cacti;

4. Succulents.

When a user directs the camera during use of the PlantSnap application, the object detection method requests information from the ML model regarding plant objects which are potentially present in the specific frame. Under an embodiment, an object detection approach known as YOLO (You Only Look Once) is used to analyze the image in each frame via a single neural network. This network divides the image in the frame into regions and predicts bounding boxes and probabilities for each region. These bounding boxes are weighted by the predicted probabilities. The object detection method provides under an embodiment a result, i.e. provides coordinates of detections which are visualized as “highlight views”. Under an embodiment, a highlight view visually informs a user that there is a plant in that area of the camera frame. The highlight view may be presented to the user as an in frame visual bounding box along with an identification that the object is a plant. The object detection approach uses under an embodiment as many detections per second as possible. The optimal amount for each device is calculated dynamically on the device currently running the model.

Under one calibration process, the time for 10 successful detections is initially determined for a specific device, i.e. how much time does each successful detection require to complete. After further calculations and aggregation of the results, the number of detections which may be handled by the current device without performance issues is determined.

A user may then tap on one of the highlight views thereby taking a photo automatically cropped in a way that centers and positions the plant properly. That image is then sent for identification using the systems and methods already described above.

A problem may arise in that objects repeat within a continued camera live feed. When a user moves the camera, for every frame, there are repeating objects under an embodiment. In other words, when a user moves the mobile device camera, the camera's frame of view shifts. A detected object may persist in the frame of view but may appear in varying locations. It is important to know which objects are still in the frame when transitions occur from one frame to the next.

Detected objects are handled as follows under an embodiment:

1. A new highlight view with the given coordinates is created.

2. The previous highlight views are compared with the new one and an overlap coefficient is computed. Under an embodiment, a comparison is made (and an overlap coefficient computed) for each respective pairing of the new highlight view with each view of the old highlight views. Under an embodiment, the overlap coefficient represents the overlapping area in a particular location relative to the perimeters of two bounding boxes.

3. If a coefficient is less than a minimum threshold, the old highlight view(s) and corresponding object are considered missing in the new frame. The object detection method then decreases the transparency of the highlight view(s); if the view(s) is classified as “missing” over multiple frames in a row (i.e. over a minimum threshold number of frames), the view(s) completely fades out.

4. If the coefficient is larger than a threshold minimum, the object detection method considers the object present in the new frame. The object might also be present in the new frame and simply moved from a prior position. (This situation is a frequent occurrence). If the coefficient is larger than a threshold minimum, the object detection method translates the old frame to the new one (i.e. translates the previous highlight view to the new highlight view when the respective overlap coefficient is above a threshold minimum) and by doing this the object detection method achieves tracking of the detected object between frames.

5. If the coefficient is 1 (which means almost no offset of the specific object compared to the object in the previous frame) and if a user's device stability coefficient is also high, the object detection method does not perform any translations of the frame to avoid glitching and trembling of the highlight views.

6. If there are highlight views in the new frame which do not overlap with any of the previous highlighted views, the object detection method considers the new view as a newly appeared object in the frame. The object detection method visualizes the new object in a highlight view if the user's device is stable enough. Note that mobile devices are generally equipped with acceleration sensors, which are used for counting steps when walking, detecting device orientation rotation, etc. The same sensors may be used to determine how stable the device currently is. Under an embodiment, mobile APIs (Apple, Android and others) provide a simple interface to get information from these sensors and actually return several states of stability. As soon as the PlantSnap application is notified that a device is in its most stable state, the application considers the device stable.

As indicated above, computer vision models or object detection models, which can vary in size, may be stored either locally, or within a cloud delivery network and be used on demand from a client application. These technologies improve the user's experience and interface by eliminating the need for the user to take a “proper” image (meaning an image which can be classified with high accuracy by the image classification model). This is achieved by detecting one of the trained image categories (plants, animals, etc.) at a location within a live camera view and performing a further image classification only within the bounding box, provided by the object detection computer vision model. A user, then, has the ability to either select one of the regions within the camera view, which contains one of expected categories, or let the client software perform an automatic “hover and detect” of such categories, where they are “collected” in an automated fashion, without the need for further user action.

A further extension of this experience includes guidance for a user to hold the camera still, as most phone cameras are limited to relatively low frames per second. A very rapid movement of the device hinders the proper detection and classification of an image category, as it usually results in a blurry image. This is achieved by detecting the intensity of device movement using provided sensor data and only performing detection and classification when the device is held still by a user. Contextual guides are provided inside the live camera view to inform user when the camera movements are performed too rapidly for an optimal detection and classification, under an embodiment. Image classification results are then provided to the user who may then compare results and select which one fits the subject best.

Under one embodiment, the PlantSnap application enables a fully automatic recognition process. A user simply holds the camera of a mobile device over a plant targeted for identification; if a plant is detected (using object detection) and identified (using image recognition) with an accuracy above a certain threshold, the application “collects” the image for the user, who may later decide whether to save the automatic result to the user's local collection. A visual guide and confirmation is present in the camera view at all times to ensure that the user understands what is currently being processed out of frame. Under one embodiment, as the PlantSnap application determines that a detected object is a viable candidate for collection, the application presents a progress visualization. In addition, the application may provide a visual confirmation that the collection operation has been performed successfully. Visual progress and confirmation indicators are provided under an embodiment in the highlight view of the detected object.

Further, features of objects may also be included inside the object detection models (e.g., the bark of a tree), which are added as enablers to the recognition process.

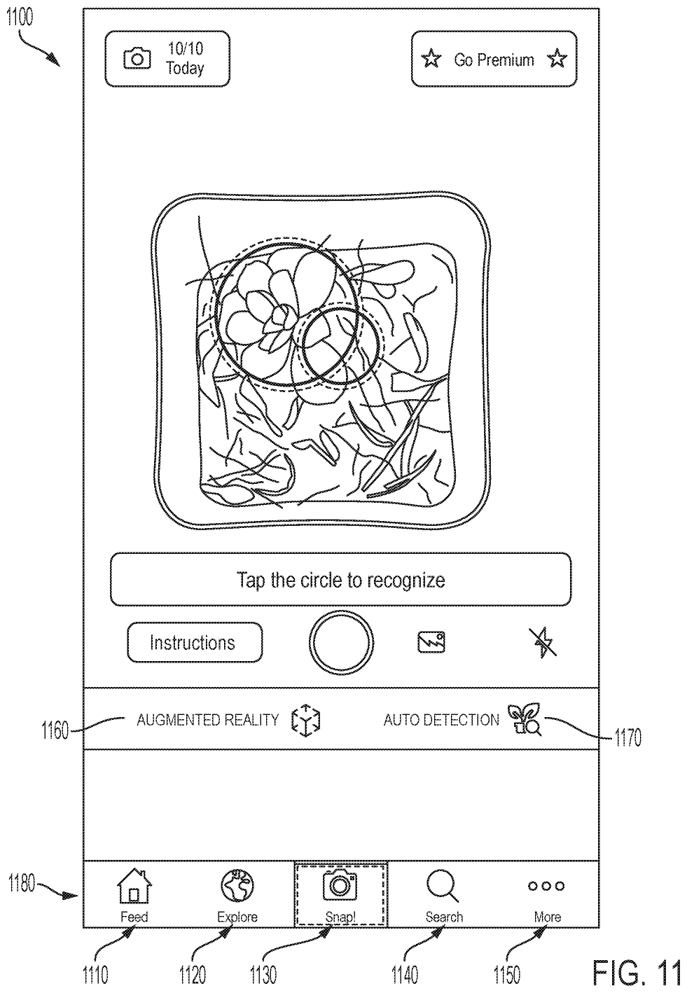

The screen 1100 of FIG. 11 shows options for activating auto-detect 1160 or augmented reality 1170. Note that auto-detection activates object detection as described above. The augmented reality feature also uses object detection as further described below.

Augmented Reality comprises a component of computer vision, which adds virtual reality objects and features to a real scene inside a live camera view.

iOS—Apple provides the ARKit platform (including ARKit 2) which enables augmented reality features. The platform provides an ability to detect distances and sizes, without the need of manually placing anchor points at corners, or other points which define the augmented reality “world geometry”. The platform also provides the ability to extract feature points in a live scene and use them to place virtual objects inside real world geometry.

“Science simulations”—by using the above-mentioned augmented reality features and combining them with the object detection features described above the systems and methods described herein are able to provide educational value by adding science simulations to real world scenery such as a photosynthesis simulation, added to a real-world leaf (flow of carbon dioxide and oxygen molecules, sun rays on a leaf), pollination, added to a real-world flower (a bee landing on a flower to gather nectar, while collecting pollen from it) and other contextually relevant biochemical and physical processes within the real-world scenery. Visual effects are complimented with sound effects to achieve a more immersive experience, under an embodiment.

Leaf plane and feature detection—the above-mentioned simulations provide an even higher educational value by detecting the exact plane of a leaf or other related real-world geometry and placing animations in relation to it. For example, this allows a photosynthesis simulation to show the exact flow of carbon dioxide and oxygen molecules underneath the actual leaf, as well as sunrays landing on its top surface. Plantsnap's object detection model (described above) is combined with the distance and depth data from the ARKit APIs, so that the application can properly place a detected object in a distance relative to the position of the user's device. This enables the ability to place and display science simulations in a proper size relative to the real world geometry.

Android—similar experiences are included in Android apps by using Google's ARCore kit, under an embodiment.

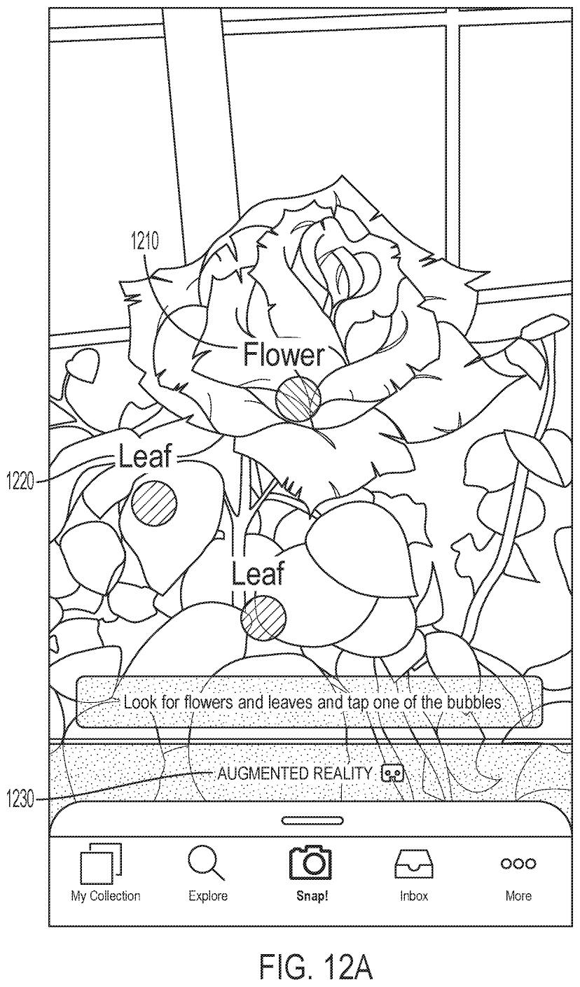

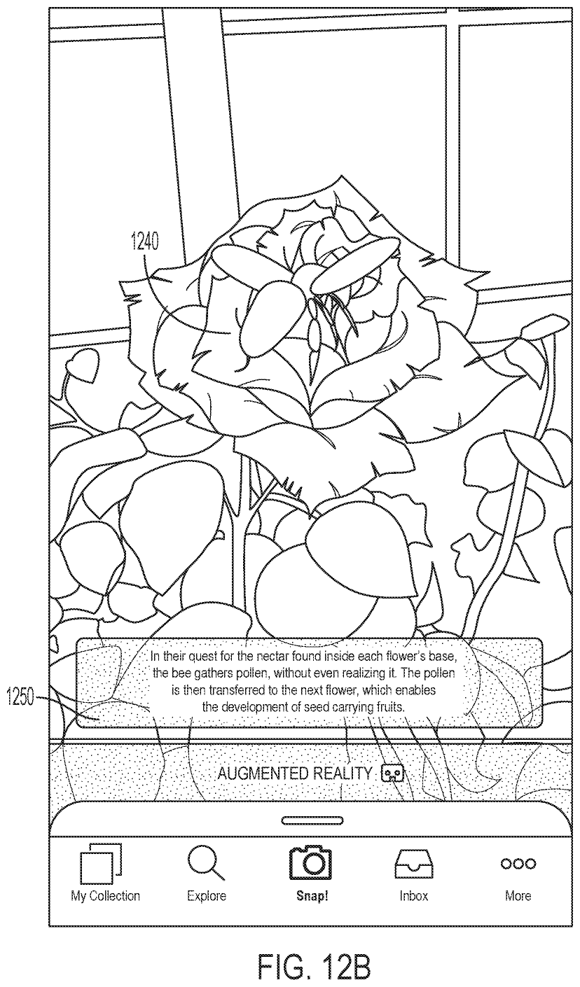

FIG. 12A shows an example of objection detection and augmented reality, under an embodiment. As seen in FIG. 12B, object detection has identified a flower object 1210 and a leaf object 1220. FIG. 12 displays the application is running in augmented reality 1230 mode. As one example of augmented reality, FIG. 12B show a bee 1240 gathering nectar/pollen from the image of the flower. The screen of FIG. 12B also states 1250: “In their quest or the nectar found inside each flower's base, the bee gathers pollen, without even realizing it. The pollen is then transferred to the next flower, which enables the development of the seed carrying fruits.”

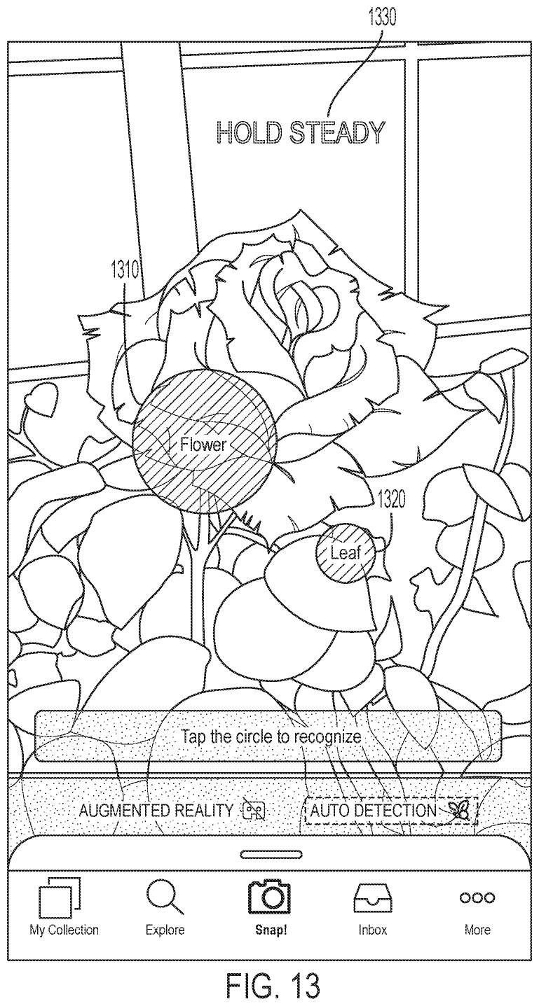

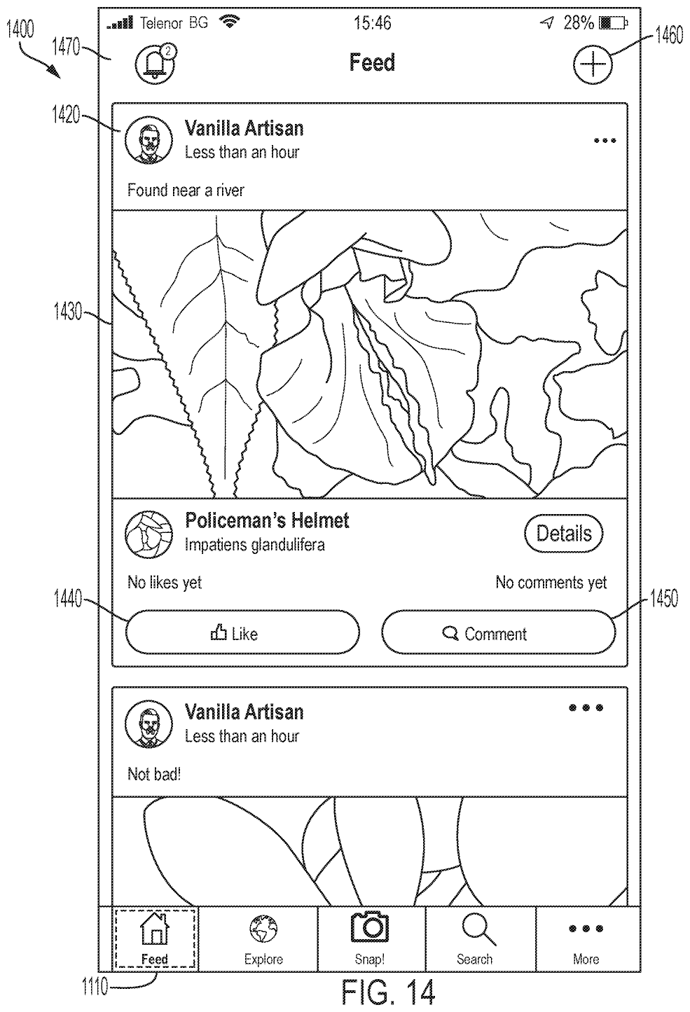

FIG. 13 shows another example of objection detection, under an embodiment. As seen in FIG. 13, object detection has identified a flower object 1310 and a leaf object 1320. Note the top of the screen displays the term “Detecting” 1330. However, the top of the screen may also display the term “Hold Steady” instructing the user to steady the camera device to assist the object detection process. In “Detecting” mode, a user may tap either of the objects to initiate image recognition as further described above. Alternatively, the PlantSnap application may automatically identify the flower/plant specifies using one or more of the detected objects.

Under one embodiment, an image recognition model is stored locally and performs the recognition directly on the device. This approach eliminates the need to perform an upload to Imagga's content endpoint and then make a separate request for the categorization. Plant details are under an embodiment retrieved from api.earth.com. A record of the user's snapshot is captured whenever there is an internet connection available. This strategy reduces the time-to-result on high end iOS devices, under an embodiment.

A backend of the Plantsnap application may provide an Application Programming Interface (API), which allows under one embodiment third-parties like Plantsnap's partners to use the technology by uploading an image file comprising a plant and receiving results for the plant's probable name and all other corresponding plant details for each result. The API may also function to make a record of every image any user takes with a user's camera or selects from a user's mobile device photo gallery for analysis, along with the identification categories that have been proposed by the image recognition. In other words, the API may function to make a record of every image a user submits for analysis together with analysis results (whether the user declines the results or not). This approach provides for a much deeper and more exhaustive analysis of why a user declines an image and provides an ability to give users feedback and improve end user experience. The API may comprise one or more applications running on at least one processor of a mobile device or one or more servers remote to the application.

The Plantsnap application may allow users to earn snapshots or snaps.

The Plantsnap platform may implement the concept of leaderboards. A user may earn snap points for snaps. Each saved or taken snap earns a point. The concept may require the following backend requirements:

API endpoints for adding, retrieving total amount of user points, weekly amount of user points, daily amount of user points.

API endpoint for checking points daily, weekly, monthly, overall.

API endpoint for rewarding the daily, weekly, monthly leader with extra points and also sending the leader a notification that the user has won.

The concept may require the following frontend requirements:

Show points gathered when taking a snap. Call to backend to update points.

Show total points and leaderboards in a user tab. Call to backend for retrieving data.

The Plantsnap platform may provide daily “login” bonuses that are later convertible to free snaps when under the freemium model as further described below. A user may receive a bonus for every day the application is open and used to take a snap. A notification may be provided to the user to remind the user to open the application and receive the bonus. The concept may require the following backend requirements:

Logic for gathering the bonuses (Day 1—50 pts, Day 2—150 pts, etc . . . ).

API endpoints for checking daily user “login” status.

API endpoint for saving user bonus points.

API endpoint for retrieving user bonus points.

API endpoint for converting user bonus points to rewards (free snaps, or something else). The concept may require the following frontend requirements:

A proper way to visualize the daily bonus collection when opening the application for the first time that day. When points are to be gathered, call to backend to check user's daily bonus status and for kind of bonus user is eligible to receive. Once a day is missed, a user starts from Day 1 again.

Showing gathered bonus points in user tab. Call to backend to retrieve bonus points.

Proper way for converting bonus points into rewards. Call to backend to validate the conversion.

The Plantsnap platform may award users skill points based on quiz results, i.e. answers to multiple choice questions selected from 4 possible plant answers. General Quizzes for guessing plants may be accessible from a section inside the application. The application may handle quizzes locally on the devices for a number of quizzes. Alternatively, the quizzes may be handled server side. Under this embodiment, a section in an application dashboard may be used define and save the quizzes, so that the quizzes may be later retrieved on the devices. The Plantsnap platform may provide inline quizzes for guessing the plant which was just snapped. This feature may be provided on an opt-in basis, so that users who don't want to participate may avoid the feature. The quiz feature described above needs backend support for showing relevant multiple choice options. An embodiment may use Imagga's™ new similar search feature to look for similar plants to make quizzes challenging.

The Plantsnap platform may provide scrabble and Guess-the-word kind of experiences.

The Plantsnap platform may provide a Plantsnap Freemium experience/service. Users may receive a few snaps for free upon initial download/use of the application. The application may use a simple counter to track snaps saved. The counter is alternatively implemented on the backend of the Plantsnap platform. When a user downloads the application an anonymous user is created in Firebase™ and the appropriate amount of snap credits are added. If they choose to register, the credits are transferred to the registered user. The concept described above may require the following backend requirements:

Handle adding, subtracting and retrieving user credits.

Handle merging of users from Anonymous to Registered status and transferring snaps. The concept described above may require the following frontend requirements:

Provide a clear representation upon saving a snap that the user has a limited amount of credits left and has used “x out of y” credits. Call to API every time a user is about to use a credit to check availability and subtract when a credit has been used.

Present an offer for subscription when credits are depleted.

Block the camera/gallery experience once credits are depleted and no valid subscription exits.

The Plantsnap platform may provide a free snap credit for watching an ad served through Firebase™ under an embodiment. The concept may require the following backend requirements:

Call to API for adding a snap credit when watching an ad.

Call to API to retrieve the credit and use inside the application.

The concept may require the following frontend requirements:

Show the option when the user has run out of credits after the user is presented with the offer to buy a subscription.

Present the ad.

Call to API to add the credit.

Call to API to subtract the credit after credit been used.

There are two ways to subscribe to the Plantsnap platform. Either a user shares a subscription for a user account across platforms (iOS™, Android™) or purchases a platform specific subscription. A Monthly subscription may be available for $3.99. A yearly subscription may be available for $39.99. Under an alternative embodiment, a user may buy snap credits—buy 3 snaps for $0.99 and 10 snaps for $2.99

The subscription service may comprise the following backend requirements:

API support for adding a subscription once purchased.

API support for cancelling a subscription when cancelled.

API support for subscription upgrade/downgrades.

API support for periodically checking if a subscription is still valid or has been cancelled. The subscription service may comprise the following frontend requirements:

Periodically check if subscription is still valid or has been cancelled and make necessary calls to the API to update.

Present the offers to the users in a clear and understandable way.

Block the recognition part of the application if there is no subscription or credits left.

Unblock the recognition part of the application if there is a valid subscription.

Note that one or more of the features of the Plantsnap platform may be implemented using Firebase™ mobile application services. Under an embodiment, the Firebase™ platform is used to manage the registration and credit/point system described above.

The screen of FIG. 11 shows a snap screen 1100 a PlantSnap application, under an embodiment. FIG. 11 shows a navigation tab 1180 at the bottom of the screen. The navigation tab includes a feed tab 1110, an explore tab 1120, a snap tab 1130, a search tab 1140, and a more details tab 1150. When the application first loads, a user is initially presented with the snap screen page 1100. The user may use these tabs to navigate among a social feed page, an explore page, a snap screen page, a search page, and a profile page. (Note that the navigation tab remains visible across all such pages). The features of each page are further described below.

The PlantSnap application provides a social media component, under an embodiment. A user of the application may enter a social feed 1400 using the feed tab 1110 shown in FIG. 11. The feed 1400 shows a user's publicly shared posts and posts from friend's added to a user's network. Under one embodiment, a user may is only be able to view posts from friends. Each post features the author 1420 of the post and the posted image 1430. Each post provides both like 1440 and comment 1450 options. A user may “like” the post by toggling the “like” button 1440. Selecting the comment option 1450 opens a text box for free form text entry. The text box limits a comment to 1000 characters. Under one embodiment, the comments option exposes a chronological list of comments for the particular post. The list view may be limited to a first portion of the comments with an option to expand the view to all comments. The expanded view may involve opening a separate screen for viewing all comments. Under one embodiment, the application includes the ability to reply to comments, add images to comments and include a species (similar to when creating a post).

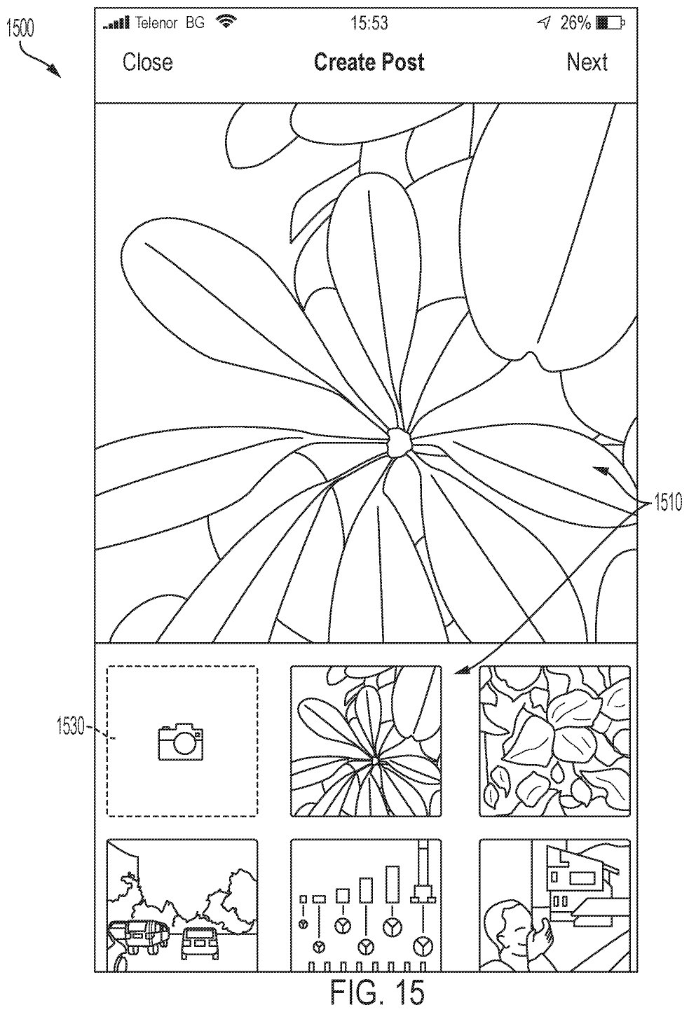

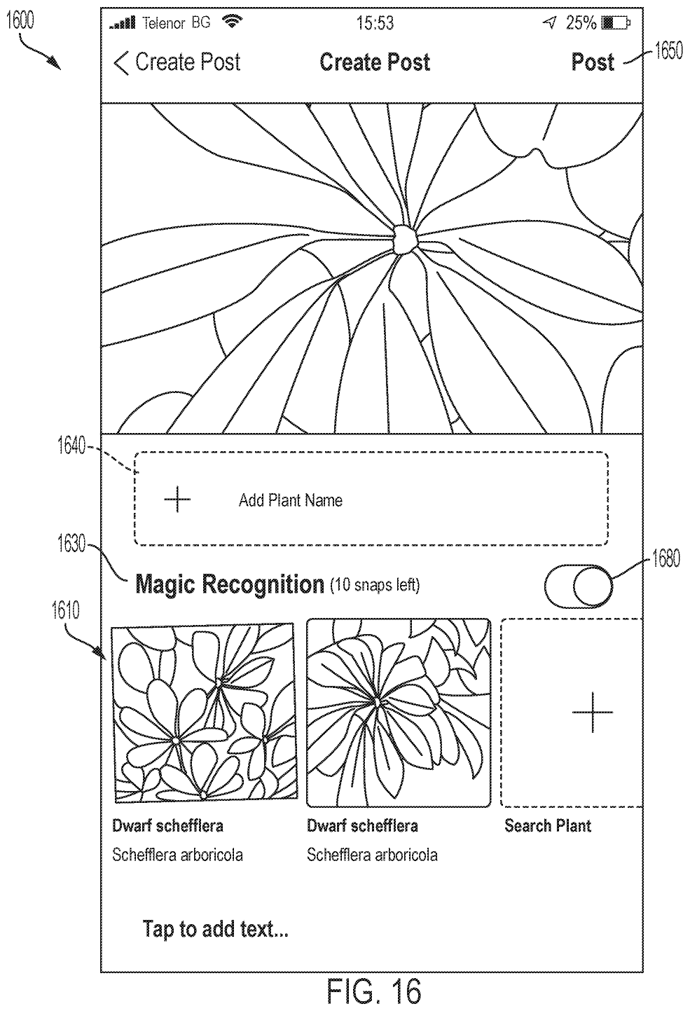

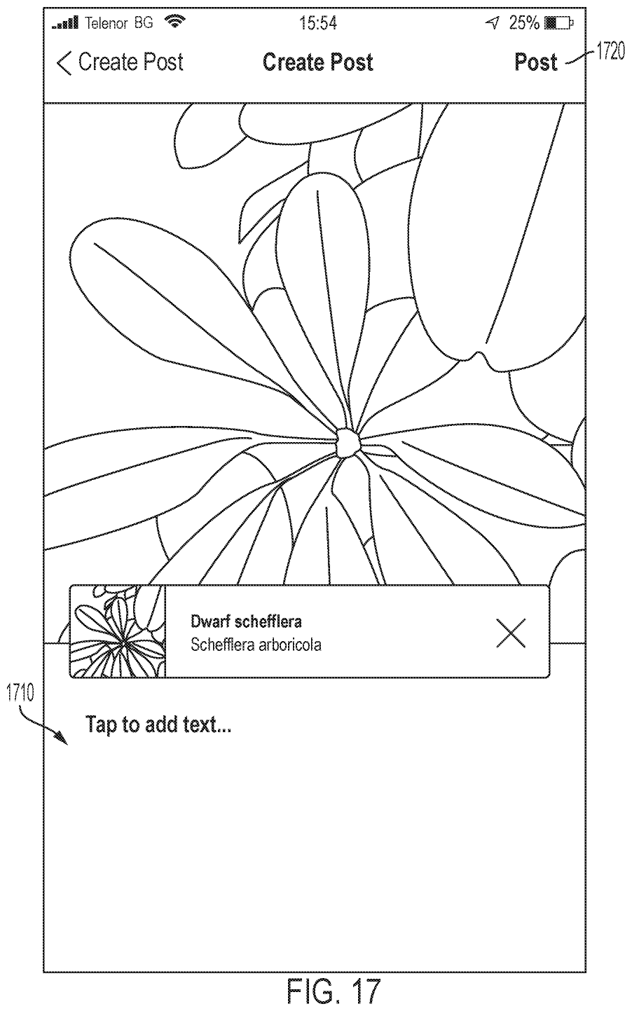

FIG. 14 provides a posting option 1460. A user selects the “+” icon 1460 to land on a “create post” 1500 page as seen in FIG. 15. The interface of FIG. 15 allows a user to select an image from the user's Plantsnap image collection 1510 which also includes any image from the camera roll. Alternatively, the user may elect to snap a new photo using the camera icon 1530. Once an image is selected, the user navigates to a view providing an option to crop/center the plant image. The user is then directed to the interface of FIG. 16 which presents the user with plant categorizations 1610 generated by the PlantSnap application. A user may select a plant identification. In the alternative, a user may input a plant name using the “Add Plant Name” 1640 feature. As yet another alternative, a user may simply post an image with no identification, i.e. no identification generated by the PlantSnap application and no identification provided by the user. If a user posts 1650 the image alone, then the application posts the image on the user's feed. The application simultaneously directs a user to the feed to view the most recent post. If a user posts 1650 an image with plant identification (either automatically or manually generated), the application passes the user to the screen of FIG. 17 which provides the additional option of adding free form text comments 1710. A user may then post 1720 the image, the identification, and additional text (if provided) to the user's feed. The application simultaneously directs a user to the feed to view the most recent post featured together with identification and/or additional comments. (Note that PlantSnap plant identification (referred to on the feed as magic recognition 1630) may be enabled or disabled as part of the social feed workflow by toggling slider 1680. The application tracks the number of magic recognition snaps available to the user.

A user may aggregate images for recognition using the Plantsnap image recognition process described above. The user may take multiple snaps and then include all of the snaps in a “container” image. The container image may indicate the Plantsnap identified species for each snap. Alternatively, a user may manually identify a species for some or all of the snaps. A user may manually resize or move the regions occupied by the snaps. The user may then post the container image (which includes multiple snaps and images) using the posting workflow described herein.

The upper left hand corner of FIG. 14 features a notification button 1470 allowing a user access to all of user's push notification. A user receives under one embodiment receives push notifications of (i) received friend requests; (ii) likes of a user's post; (iii) comments on a user's post; and (iv) accepted sent friend requests; and (v) manually identified snap notifications, i.e. snaps sent for manual identification by a botanist.

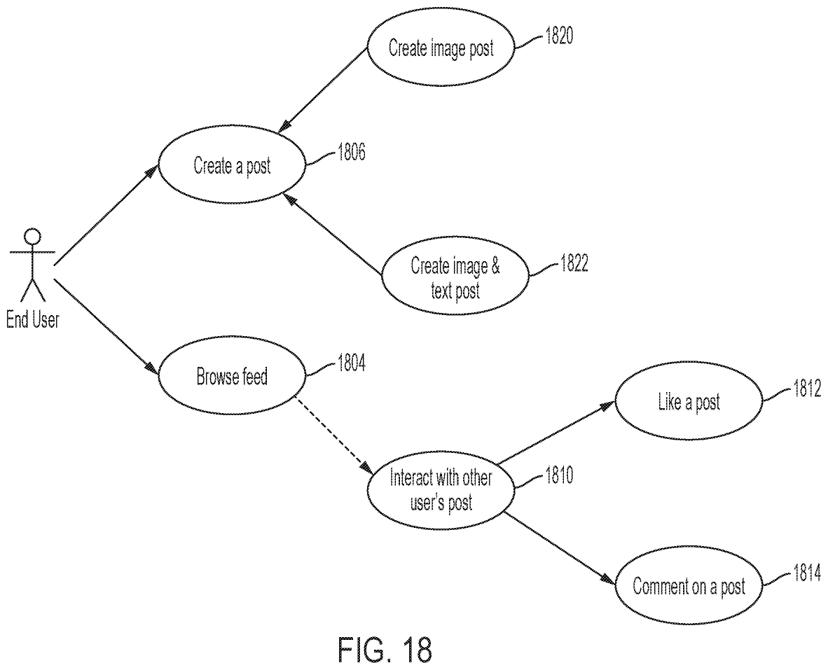

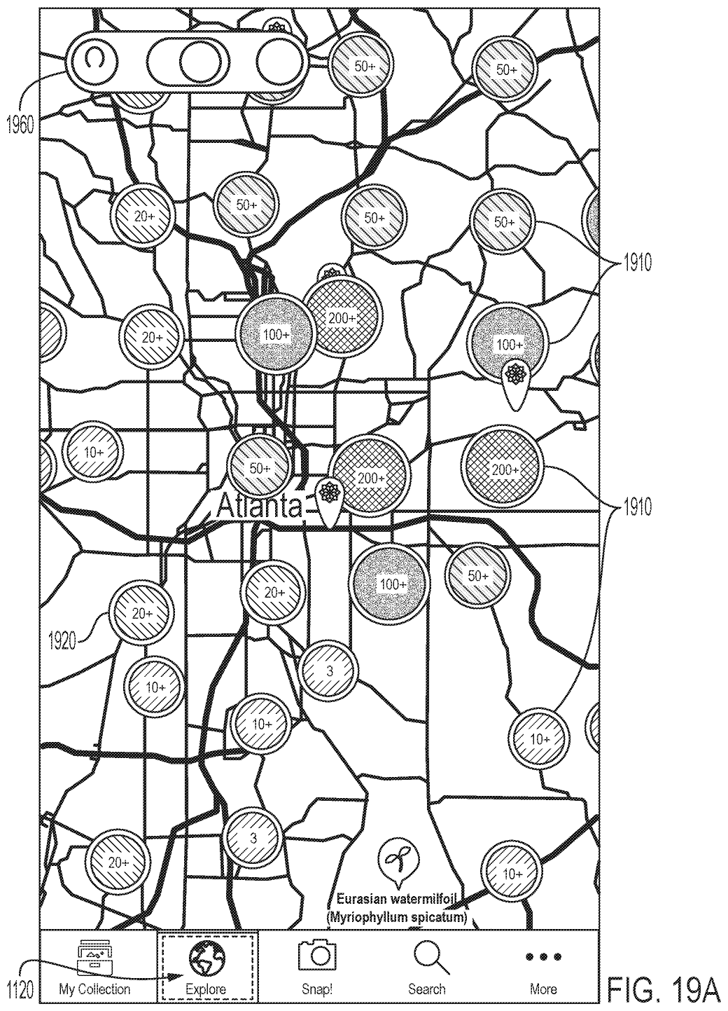

FIG. 18 shows a workflow for posting to a PlantSnap social feed, under an embodiment. A user may browse the social network feed 1804. A user may then interact 1810 with posts generated by friend users. In other words, a user may like 1812 another user's post or comment upon 1814 another user's post. While browsing the feed, a user may at any time create an image post 1806, 1822 (i.e. image without comment or identification) or an image post with identification and potentially additional comment 1806, 1822.

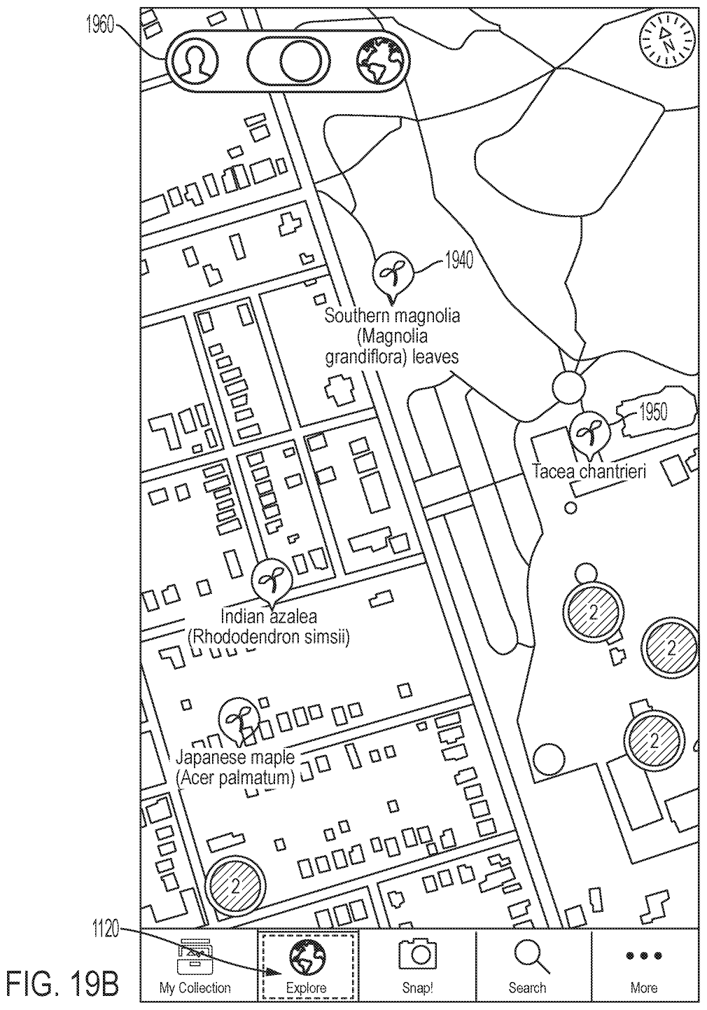

The PlantSnap application provides users with an explore option. A user of the application may enter the explore screen using the screen tab 1120 as seen in FIG. 11. FIGS. 19A and 19B show the explore screen. FIG. 19A shows PlantSnap users (e.g. 1910, 1920) in the Atlanta, Georgia area. The circular icons 1920 indicates a user that has taken 20+ snaps. A user may select one of the circular icons to zoom in on an area and view locations of specific plants 1940, 1950 (See FIG. 19B). FIGS. 19A and 19B provide the user a toggle 1960 for switching between the view showing snaps of all PlantSnap users and to a view showing only snaps of the primary user. In the “all snaps” mode, a user may scroll to an location on earth to view potential users.

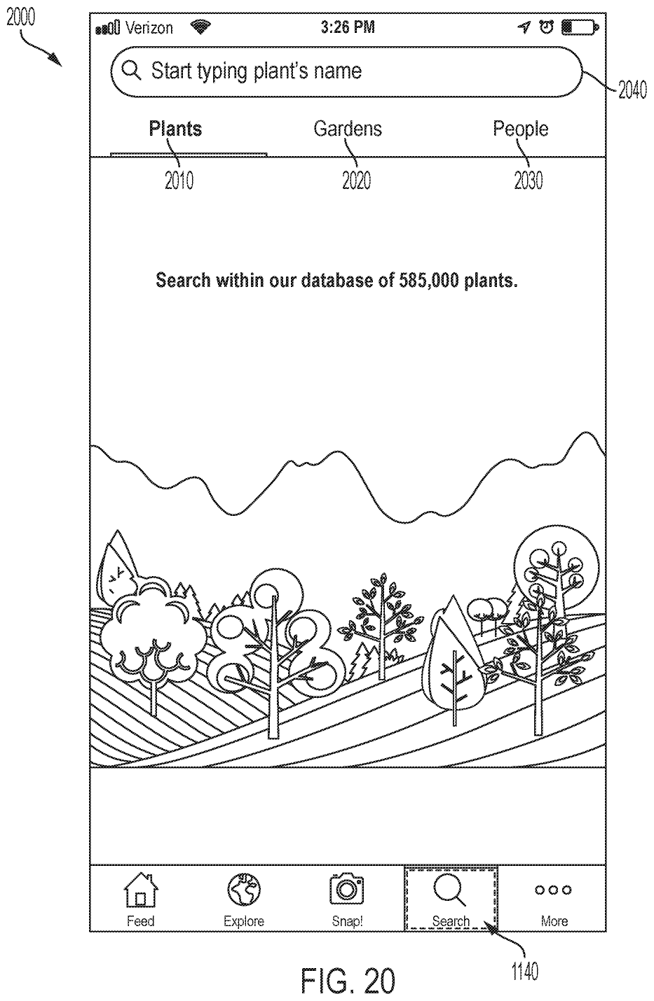

The PlantSnap application provides users with search options. A user of the application may enter a search screen using the screen tab 1140 as seen in FIG. 11. The search screen 2000 (shown in the upper portion of FIG. 20) provides a plants tab 2010, a gardens tab 2020 and a people 2030 tab. Each tab enables a corresponding search, i.e. a search for plants, gardens, or people. Search terms for each type of search are entered into ribbon 2040 at the top of the screen. The plant search provides searching capability among a database of 585,000 plants. The gardens search identifies gardens and additional garden details including garden summary, location, contact information, and website. The people search page provides the ability to search for PlantSnap users. Each user may then use this feature to identify and invite/add new friends to the user's social network.

The PlantSnap application provides users a details tab 1150 as seen at the bottom of the snap screen 1100 shown in FIG. 11. A user of the application enters the details page using the details tab 1150. The details page (also referred to as a profile page) may present a user with a list of friends, saved snaps (alternatively stored as a “My Collection” as described above), and a list of the user's posts. A user may click through a listed image of a friend to access the friend's posts. A user may interact with these posts in the same manner as provided in the social feed. Also, a user may click on the image of a friend to view that particular user's set of friends. A user may then select these individuals to invite/add them as a new friend.

A user make select the settings button on the profile page to access an interface for (i) changing display name; (ii) changing email address; (iii) change passwords; (iv) reset password; and (v) logout.

The PlantSnap incorporates the social networking component in the general onboarding experience, under one embodiment. A new of first time user of PlantSnap walks through a registration process which includes an onboarding flow. The onboarding flow includes a slider stepping through an overview and general explanation of the application. The onboarding flow includes interaction with the user to request/enable permissions for the PlantSnap application (e.g. access to camera and location awareness). The onboarding flow includes a registration page (i.e. create username, password, and display name). Upon registering successfully, the user will be required to input a little more information about themselves which builds up their profile (e.g. a user may provide a profile picture and list of favorite plants). Additionally, a user is presented with a step-by-step tutorial explaining the general flow of the application and teaching its use in snapping and identifying plant images. The onboarding flow may then present the user with an option to invite friends to join the user's network. The user is provided with a search option to search for friends. (Note that this is the same search option provided by the people search page accessible by selecting the search tab 1140 of FIG. 11 and then the people 2030 tab of FIG. 20). The application may present the user with proposed friend invites. These proposed invites are based on location, favoring users in the vicinity, as well as popular users, who are using the social features very often.

The application may provide social network hints for first time users of the social feed. As one example, a user opening the feed for the first time is presented with an option to invite friends to join the user's network (as described above). The application may also present the first time social feed user with proposed friend invites (as described above), under one embodiment.

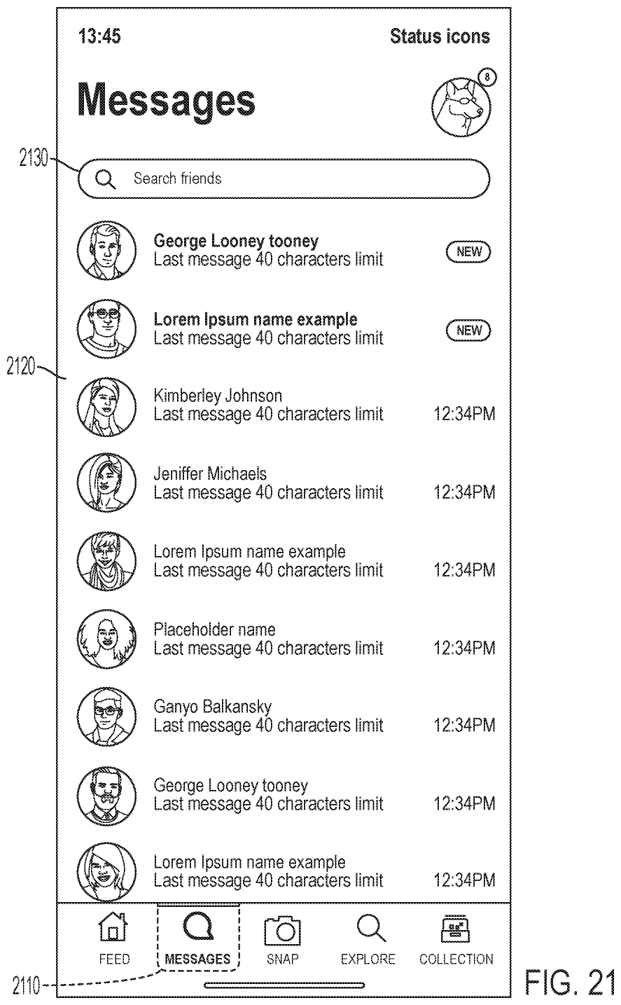

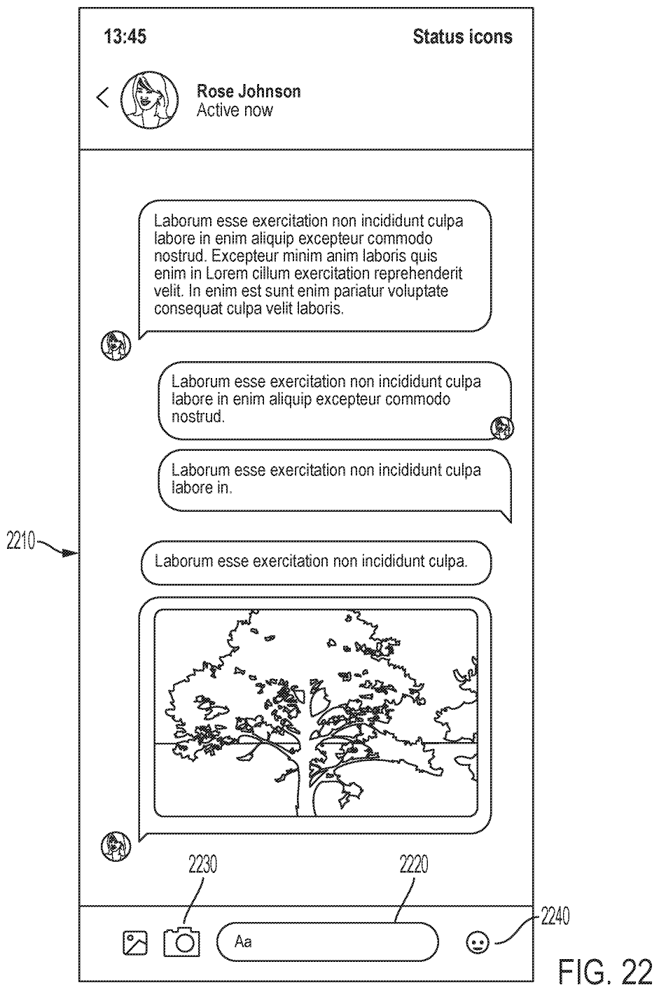

FIGS. 21 and 22 show direct messaging capability. A user may access direct messaging through a messaging tab visible 2110 at the bottom of the PlantSnap application. The messaging tab is an additional tab added to the navigation bar 1180 of the screen shown in FIG. 11, under an alternative embodiment. Using the direct messaging interface, a user may search friends for direct messaging by entering names in the search bar 2130. Alternatively, a user may simply select an ongoing message thread 2120. In either event, a user then communicates with a selected friend using the messaging interface of FIG. 22. The interface of FIG. 22 shows a message thread 2210 and text input box 2220. The user may use the camera option 2230 to take and send images or send any image from the camera roll. The user may use option 2240 to include emoji content in the direct messaging exchange.

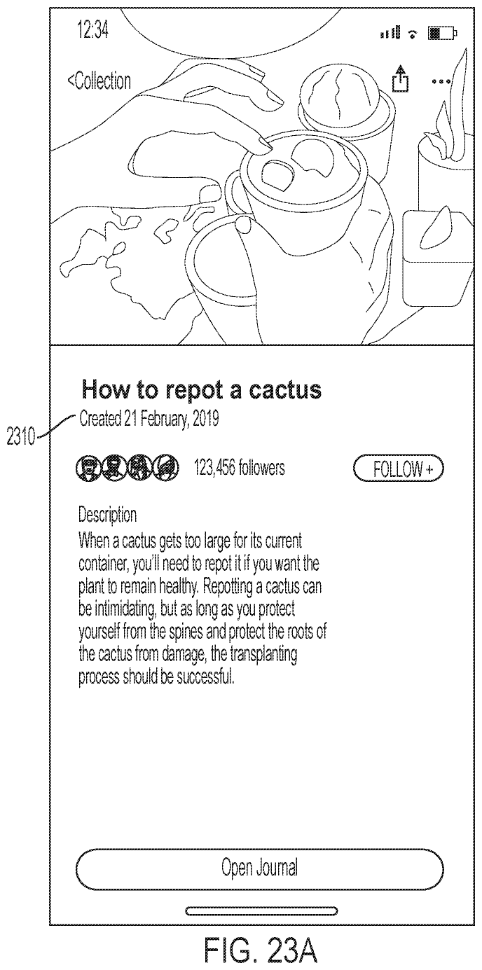

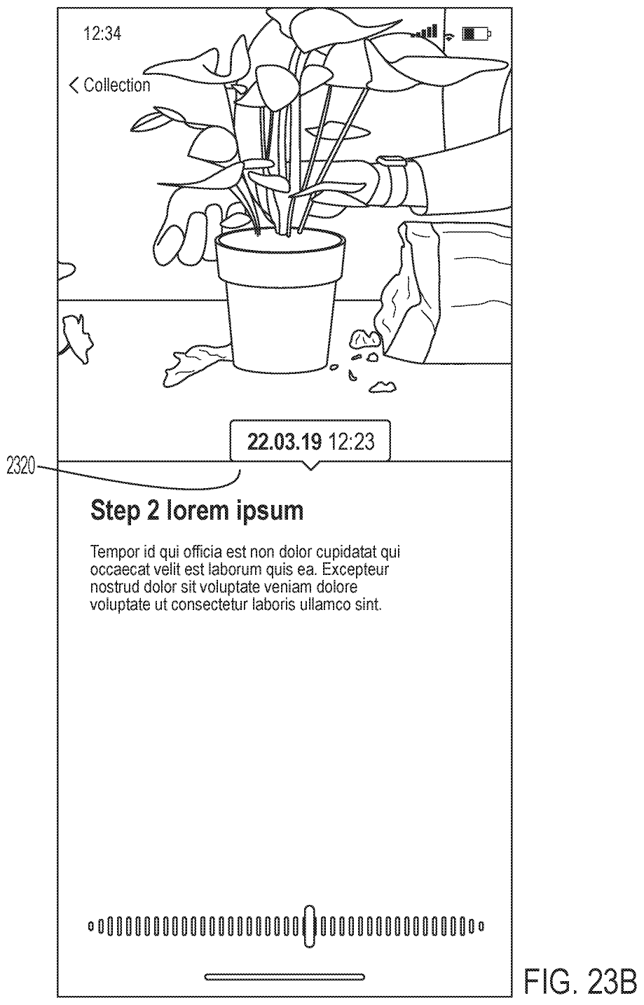

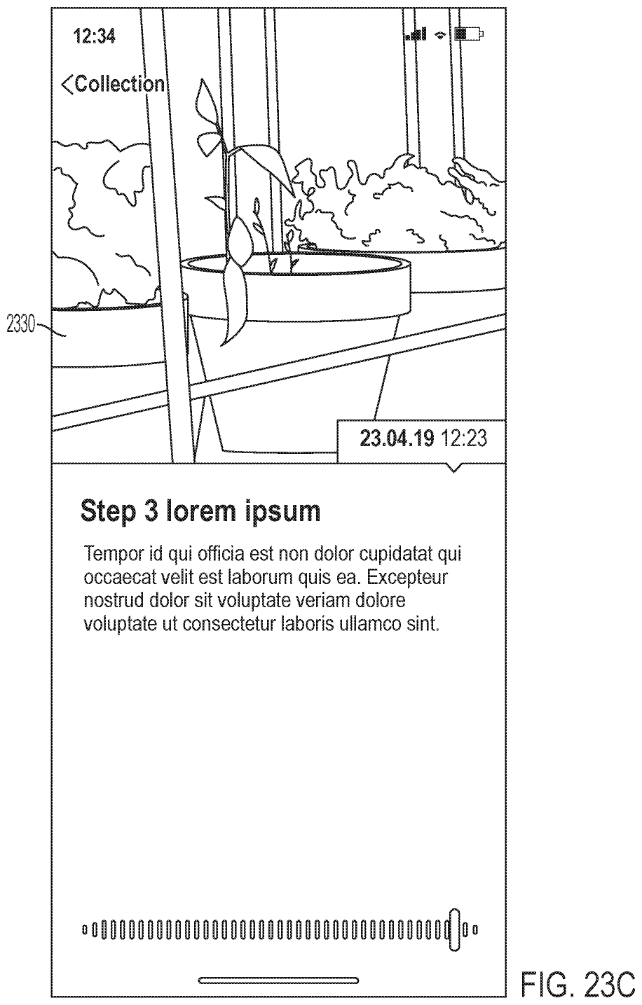

FIGS. 23A-23C represent a collection of posts which are organized in a timeline. The collection of posts are referred to as a journal. A journal can include anything from users showing plants or garden as they grow and evolve, users showing changes in plants or gardens during the seasons, and users sharing step by step instructions for how-to perform different operations related to plants—potting, planting, etc. Brands are able to create brand accounts and share content in this engaging format. FIGS. 23A-23C represent a journal describing how to repot certain plants. The journal includes three posts created over a period of time on three different days (2310, 2320, 2330). A separate Journals feed may be accessible through a collections tab feature on a navigation ribbon as seen at the bottom of FIG. 11. Otherwise, a user creates and view journals using a journal option (i.e. an option to create and aggregate posts) provided in the social feed already described above. The user's journals are also visible on the user's profile page.

Users may purchase products directly from within the application. PlantSnap approved vendors provide product feeds including Plant Name, Plant Image, Plant Species Name, Plant Normal Price, Plant Availability (in stock, out of stock), Plant Sale Status (on sale, not on sale), Plant Sale Price, and Plant URL (i.e., a URL directed to website for purchase of a particular plant).

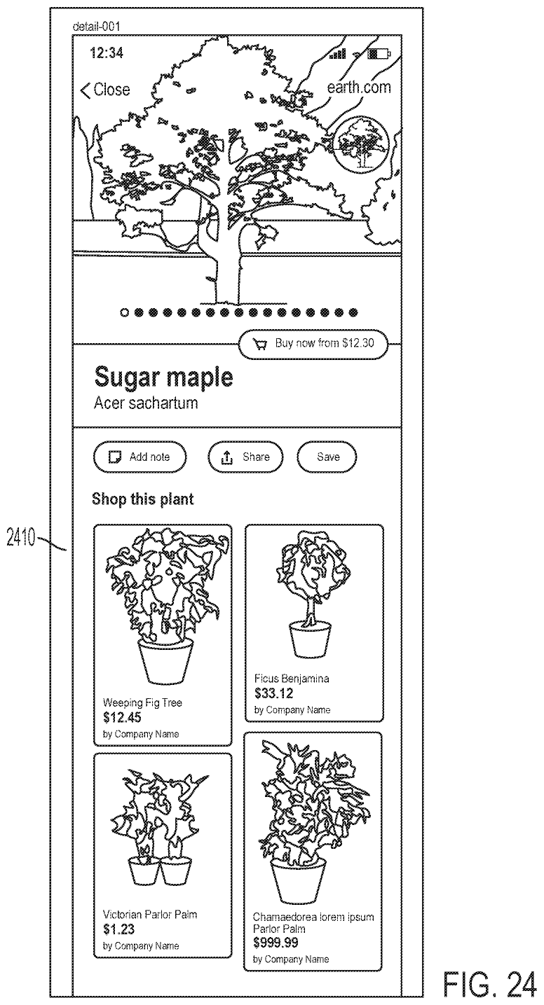

The product feeds are up-to-date and updated every time a change has been made to a product—price change, stock status change, sale status change, etc. The application presents approved vendor products through the specific detail screens corresponding to plant identifications. According to standard PlantSnap recognition workflow described above, a user snaps an image of a plant and is then presented with primary and secondary plant identifications. A user may at any time select a plant/flower image to retrieve additional detail regarding the plant. Selection of an image clicks a user through to a detailed description of the plant/image (see FIGS. 6 and 7 and corresponding disclosure material). The detailed description may comprise an earth.com page providing specific plant detail. An embodiment of the earth.com page presents an option to purchase the plant from approved vendors. FIG. 24 provides a user various options 2410 to buy a sugar maple. Tapping on any of the suggested products directs the user to a URL for purchase of the product from an online store.

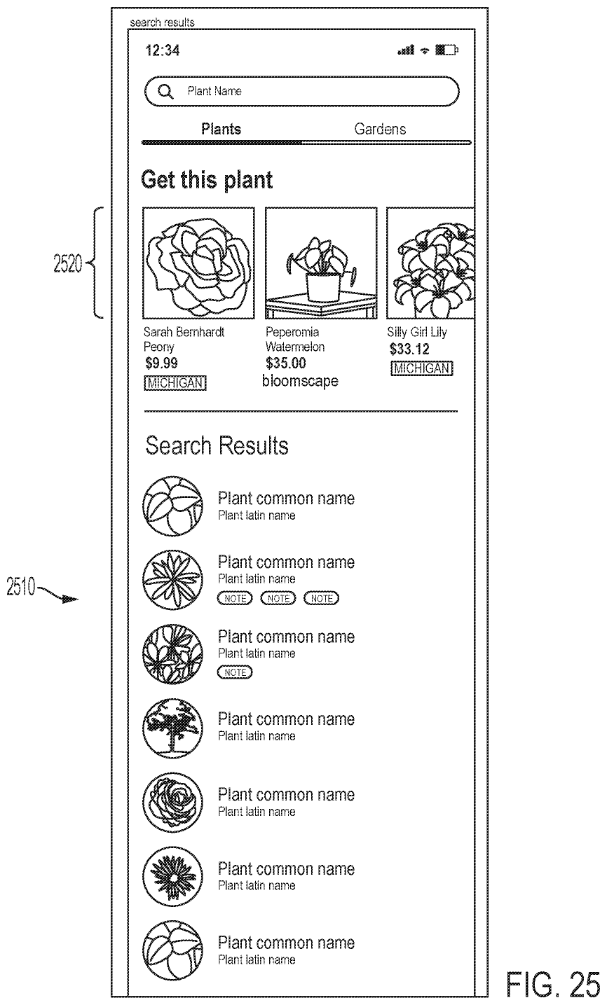

A user may manually initiate a plant search using the search page of FIG. 20 as described above. FIG. 25 shows the results 2510 of a plant search. FIG. 25 provides various offers to purchase plants 2520. The plants 2520 offered for purchase may represent the top three items returned by the plant search. Tapping on any of the suggested products directs the user to a URL for purchase of the product from an online store.

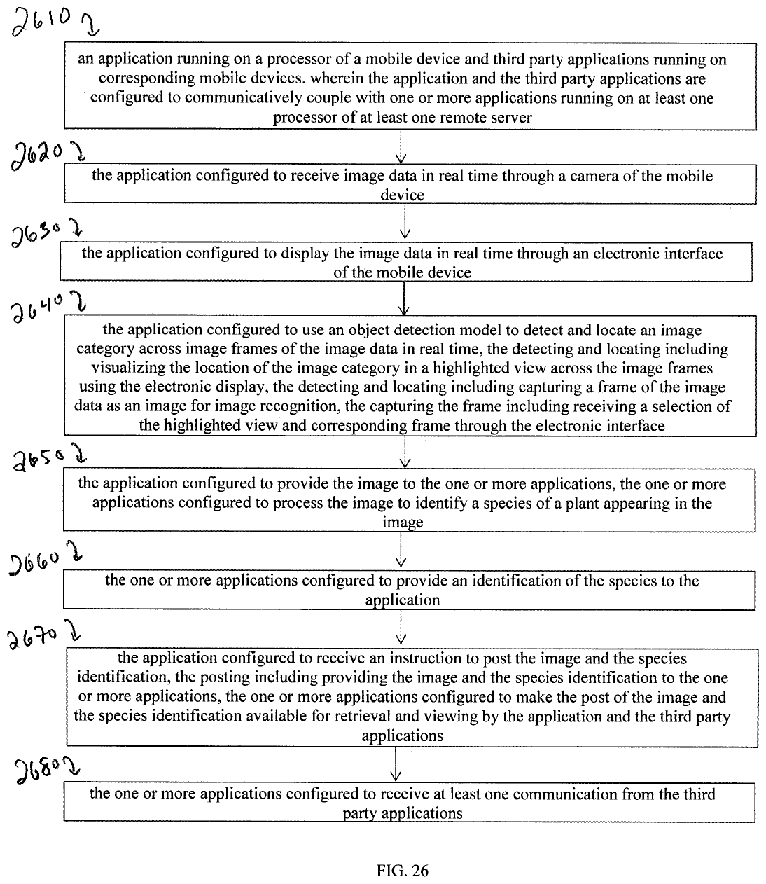

FIG. 26 shows a system for object detection, plant identification, and sharing of plant identification, under an embodiment. The system includes 2610 an application running on a processor of a mobile device and third party applications running on corresponding mobile devices. wherein the application and the third party applications are configured to communicatively couple with one or more applications running on at least one processor of at least one remote server. The system includes 2620 the application configured to receive image data in real time through a camera of the mobile device. The system includes 2630 the application configured to display the image data in real time through an electronic interface of the mobile device. The system includes 2640 the application configured to use an object detection model to detect and locate an image category across image frames of the image data in real time, the detecting and locating including visualizing the location of the image category in a highlighted view across the image frames using the electronic display, the detecting and locating including capturing a frame of the image data as an image for image recognition, the capturing the frame including receiving a selection of the highlighted view and corresponding frame through the electronic interface. The system includes 2650 the application configured to provide the image to the one or more applications, the one or more applications configured to process the image to identify a species of a plant appearing in the image. The system includes 2660 the one or more applications configured to provide an identification of the species to the application. The system includes 2670 the application configured to receive an instruction to post the image and the species identification, the posting including providing the image and the species identification to the one or more applications, the one or more applications configured to make the post of the image and the species identification available for retrieval and viewing by the application and the third party applications. The system includes 2680 the one or more applications configured to receive at least one communication from the third party applications.

A system is described that comprises under an embodiment an application running on a processor of a mobile device and third party applications running on corresponding mobile devices. wherein the application and the third party applications are configured to communicatively couple with one or more applications running on at least one processor of at least one remote server. The system comprises the application configured to receive image data in real time through a camera of the mobile device. The system comprises the application configured to display the image data in real time through an electronic interface of the mobile device. The system comprises the application configured to use an object detection model to detect and locate an image category across image frames of the image data in real time, the detecting and locating including visualizing the location of the image category in a highlighted view across the image frames using the electronic display, the detecting and locating including capturing a frame of the image data as an image for image recognition, the capturing the frame including receiving a selection of the highlighted view and corresponding frame through the electronic interface, The system comprises the application configured to provide the image to the one or more applications, the one or more applications configured to process the image to identify a species of a plant appearing in the image. The system comprises the one or more applications configured to provide an identification of the species to the application. The system comprises the application configured to receive an instruction to post the image and the species identification, the posting including providing the image and the species identification to the one or more applications, the one or more applications configured to make the post of the image and the species identification available for retrieval and viewing by the application and the third party applications. The system comprises the one or more applications configured to receive at least one communication from the third party applications.

The at least one communication of an embodiment includes one or more of an approval of the post and free form comments relating to the post.

The one or more applications of an embodiment are configured to make available the at least one communication for retrieval and viewing by the application and the third party applications.

The posting includes providing a series of images and corresponding text comments to the one or more applications, the one or more applications making the series available for retrieval and viewing by the application and the third party applications, wherein the series includes the post of the image and the species identification, under an embodiment.

The processing the image includes providing the image to an image recognition API for identification, under an embodiment.

The one or more applications of an embodiment are configured to receive a request from at least one of the application and the third party applications to view details relating to the plant identification.

The one or more applications of an embodiment are configured to make the details available for retrieval and viewing by the application and the third party applications.

The details of an embodiment include a listing of at least one option to purchase a plant corresponding to the plant identification, the listing comprising URLs directed to at least one vendor website offering the plant for sale.

The highlighted view of an embodiment labels the image category.

The object detection model of an embodiment is trained using an annotated database of images, wherein each image includes at least one image category, wherein the annotated database includes bounding box coordinates of the at least one image category appearing in each image, wherein bounding box coordinates locate an image category within an image using a predefined coordinate system, wherein the at least one image category includes the image category.

The detecting and locating includes detecting and locating the image category across image frames at a sampling rate, under an embodiment.

The object detection model of an embodiment comprises a “You Only Look Once” (YOLO) analysis of the frames.

The detecting and locating the image category across the frames includes comparing each new highlighted view with previous highlighted views, under an embodiment.

The system of an embodiment includes computing an overlap coefficient for each respective pair of the new highlighted view and each view of the old highlighted views.

The system of an embodiment includes adjusting transparency of a previous highlighted view to fade the view when the respective overlap coefficient is below a threshold level.

The system of an embodiment includes fading out a previous highlighted view when the respective overlap coefficient is below a threshold level over a designated number of frames.

The system of an embodiment includes translating a previous highlight view to the new highlight view when the respective overlap coefficient is above a threshold level.

The system of an embodiment includes detecting a stability coefficient of the mobile device capturing the image data.

The system of an embodiment includes maintaining a previous highlight view when the respective overlap coefficient is one and when the stability coefficient is above a designated value.

The image category of an embodiment includes comprises a leaf.

The image category of an embodiment includes comprises a flower.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The systems and methods for electronically identifying plant species can be a component of a single system, multiple systems, and/or geographically separate systems. The systems and methods for electronically identifying plant species can also be a subcomponent or subsystem of a single system, multiple systems, and/or geographically separate systems. The components of systems and methods for electronically identifying plant species can be coupled to one or more other components (not shown) of a host system or a system coupled to the host system.

One or more components of the systems and methods for electronically identifying plant species and/or a corresponding interface, system or application to which the systems and methods for electronically identifying plant species is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the systems and methods for electronically identifying plant species can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods for electronically identifying plant species and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods for electronically identifying plant species and corresponding systems and methods include: microcontrollers with memory (such as electronically erasable programmable read only memory (EEPROM)), embedded microprocessors, firmware, software, etc. Furthermore, aspects of the systems and methods for electronically identifying plant species and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods for electronically identifying plant species is not intended to be exhaustive or to limit the systems and methods to the precise forms disclosed. While specific embodiments of, and examples for, the systems and methods for electronically identifying plant species and corresponding systems and methods are described herein for illustrative purposes, various equivalent modifications are possible within the scope of the systems and methods, as those skilled in the relevant art will recognize. The teachings of the systems and methods for electronically identifying plant species and corresponding systems and methods provided herein can be applied to other systems and methods, not only for the systems and methods described above.

The elements and acts of the various embodiments described above can be combined to provide further embodiments. These and other changes can be made to the systems and methods for electronically identifying plant species and corresponding systems and methods in light of the above detailed description.

We claim:

1. A system comprising,
an application running on a processor of a mobile device and third party applications running on corresponding mobile devices. wherein the application and the third party applications are configured to communicatively couple with one or more applications running on at least one processor of at least one remote server;
the application configured to receive image data in real time through a camera of the mobile device;
the application configured to display the image data in real time through an electronic interface of the mobile device;
the application configured to use an object detection model to detect and locate an image category across image frames of the image data in real time, the detecting and locating including visualizing the location of the image category in a highlighted view across the image frames using the electronic display, the detecting and locating including capturing a frame of the image data as an image for image recognition, the capturing the frame including receiving a selection of the highlighted view and corresponding frame through the electronic interface;
the application configured to provide the image to the one or more applications, the one or more applications configured to process the image to identify a species of a plant appearing in the image;
the one or more applications configured to provide an identification of the species to the application;
the application configured to receive an instruction to post the image and the species identification, the posting including providing the image and the species identification to the one or more applications, the one or more applications configured to make the post of the image and the species identification available for retrieval and viewing by the application and the third party applications;
the one or more applications configured to receive at least one communication from the third party applications.

2. The system of claim 1, the at least one communication including one or more of an approval of the post and free form comments relating to the post.

3. The system of claim 2, the one or more applications configured to make available the at least one communication for retrieval and viewing by the application and the third party applications.

4. The system of claim 1, the posting including providing a series of images and corresponding text comments to the one or more applications, the one or more applications making the series available for retrieval and viewing by the application and the third party applications, wherein the series includes the post of the image and the species identification.

5. The system of claim 1, the processing the image including providing the image to an image recognition API for identification.

6. The system of claim 1, the one or more applications configured to receive a request from at least one of the application and the third party applications to view details relating to the plant identification.

7. The system of claim 6, the one or more applications configured to make the details available for retrieval and viewing by the application and the third party applications.

8. The system of claim 7, the details including a listing of at least one option to purchase a plant corresponding to the plant identification, the listing comprising URLs directed to at least one vendor website offering the plant for sale.

9. The system of claim 1, wherein the highlighted view labels the image category.

10. The system of claim 1, wherein the object detection model is trained using an annotated database of images, wherein each image includes at least one image category, wherein the annotated database includes bounding box coordinates of the at least one image category appearing in each image, wherein bounding box coordinates locate an image category within an image using a predefined coordinate system, wherein the at least one image category includes the image category.

11. The system of claim 10, the detecting and locating including detecting and locating the image category across image frames at a sampling rate.

12. The system of claim 11, wherein the object detection model comprises a “You Only Look Once” (YOLO) analysis of the frames.

13. The system of claim 11, the detecting and locating the image category across the frames including comparing each new highlighted view with previous highlighted views.

14. The system of claim 13, computing an overlap coefficient for each respective pair of the new highlighted view and each view of the old highlighted views.

15. The system of claim 14, adjusting transparency of a previous highlighted view to fade the view when the respective overlap coefficient is below a threshold level.

16. The system of claim 15, fading out a previous highlighted view when the respective overlap coefficient is below a threshold level over a designated number of frames.

17. The system of claim 14, translating a previous highlight view to the new highlight view when the respective overlap coefficient is above a threshold level.

18. The system of claim 14, detecting a stability coefficient of the mobile device capturing the image data.

19. The system of claim 18, maintaining a previous highlight view when the respective overlap coefficient is one and when the stability coefficient is above a designated value.

20. The system of claim 1, wherein the image category comprises a leaf.

21. The system of claim 1, wherein the image category comprises a flower.
